(19) United States
(12) Patent Application Publication
(10) Pub. No.: US 2008/0199575 A1
(43) Pub. Date: Aug. 21, 2008

(54) Treatment of Fish Flesh

(75) Inventors: Hanne Marie Ratvik Morkemo, Trondheim (NO); Turid Morkore, Oslo (NO)

Correspondence Address: CHRISTIAN D. ABEL, ONSAGERS AS, POSTBOKS 6963 ST. OLAVS PLASS, NORWAY, N-0130, NO

(73) Assignee: INSTITUT FOR AKVAKULTURFORSKNING AS, As (NO)

(21) Appl. No.: 11/995,202

(22) PCT Filed: Jul. 13, 2006
(86) PCT No.: PCT/NO2006/000277

§ 371 Date: Mar. 11, 2008

Related U.S. Application Data
(60) Provisional application No. 60/698,467, filed on Jul. 13, 2005.

(51) Int. Cl. A23L 1/325; A23B 4/12

(52) U.S. Cl. 426/303; 99/516

(57) ABSTRACT

A method is described for treating fish flesh with basic and possibly acidic solutions in the form of baths, spraying or injection in order to improve technical and sensory properties in the fish flesh, fish flesh treated by the method and a plant for treating the fish flesh.

The present invention relates to a method for treating fish flesh by controlling the acidity in the fish flesh in order thereby to provide a product which fulfils quality factors such as taste, smell, firmness, lightness, degree of gaping and shelf life. Some important quality parameters for fish are taste, texture, colour and the raw material's processing and preserving attributes. In the art, the term quality is divided into five groups:
1. Sensory quality (colour, smell, taste, consistency).
2. Technological quality (gaping, water-retention, size, processing).
3. Nutritional quality (fat, protein, carbohydrates, minerals, vitamins).
4. Hygienic quality (bacteria, viruses).
5. Ethical quality (sustainability, GMO (gene-modified organisms)).

There are several factors involved in quality, such as structure and chemical composition of muscular tissue, biological condition, nutritional status, fishing method and handling after killing.

Water-Retention in Muscle

Water-retention capacity may be defined as the ability of foodstuffs to retain their own water or added water. It is principally the myofibril proteins myosin, actin and possibly tropomyosin, which are responsible for water-retention in muscle. Water-retention capacity is a quality criterion in fish and is well-known as a crucial property with regard to taste, consistency, colour, drip loss, and is of major importance in connection with production.

There are several parameters involved in determining the water-retention capacity of fish muscle, such as:
1. Factors related to the actual muscle, including age, gender, species, muscle type, length of sarcorneres, amount of fat, size of the animal, pH, rate of pH drop, final pH physiological condition, ATP loss, ionic strength, rigor status.
2. External factors, such as treatment before slaughter, feed, season, fishing grounds, slaughter method, slaughter stress, prerigor and postrigor procedures, storage conditions, heat treatment, drying.

The question of how great an influence the various parameters have on the water-retention capacity is under discussion, and we shall now specify some of these parameters.

Water-Retention Capacity and pH

pH is the parameter that is most frequently mentioned in the literature in connection with water-retention. The pH in fish post mortem changes during the days after death. It is known that the ultimate pH in fish muscle post mortem is around 6.2-6.6 and this final pH affects the water-retention capacity. In living cod, the pH is around 7. The pH in cod muscle post mortem has been observed as low as 5.9 by Love (1979).

In several experiments the water-retention capacity of farmed cod has been shown to be lower than in wild cod and this may appear to coincide with low pH in muscle (Losnegard et al., 1986). Lower water-retention has also been demonstrated in fed wild cod, which may be due to intensive feeding (Love, 1979; Ang & Haard, 1985). One of the inventors has carried out an experiment on the connection between pH and water loss in fish fillets from farmed cod. This experiment showed that the water loss dropped from approximately 12% of the muscle mass at pH 6 to 2% at pH 6.4.

Even though there seems to be a connection between pH and water-retention capacity, pH alone cannot explain the variation in water-retention capacity. The processing of the fish must also be taken into consideration as representing an important factor in improving water-retention.

Analyses of Water-Retention Capacity

Water-retention capacity in fish muscle can be analysed in several different ways. Run-off water from pieces of whole fillets in cold storage for a given number of days will reflect run-off from the whole fillet. By centrifuging fish muscle or by homogenization, a picture will be obtained of the fish muscle's water-retention capacity when used as forcemeat.

Texture

Texture is one of the most important quality parameters as regards fish products, and is a term that describes the consumers' perception of a product from how it feels to touch to its feel in the mouth. Texture is associated with mechanical (firmness, elasticity), structural (coarseness, fibrousness) and chemical juiciness) properties of a product (Rørå, 1995). Texture is difficult to describe, being composed of many sensations, and difficult to measure by instruments. Generally speaking, the texture of raw cod should be firm and resilient. Soft fish is associated with poor quality. However, it is essential that the fish does not become tough in texture after cooking. Cod that is tough-textured after cooking can be a problem, particularly with farmed cod. The main reason is high liquid loss, causing the fish flesh to feel coarse and fibrous in the mouth. Instrumental methods exist for measuring texture, but a standardised method has yet to be found. Sensory evaluation by means of a test panel is the most generally recognised method of telling how the consumers perceive good quality with regard to texture. Experiments carried out by the inventors showed a correlation between instrumental and sensory measurements of firmness in raw and cooked cod. Thus it appears to be possible to predict firmness in cooked cod by measuring firmness instrumentally in raw cod. Texture is influenced by several different factors extending from physiological to biochemical. Two of the factors will be discussed further. These are pH/water content and size. A third factor is prerigor and postrigor filleting. With prerigor filleting, the treatment time is shortened, the fish reaches the consumers more quickly and the product is fresher. However, not only positive effects are experienced with this method, since the fillet is shortened by up to 20-25% during rigor and the surface takes on a lumpy appearance. The muscle released a lot of liquid and became rubbery and tough. One of the inventors has carried out experiments with sensory analyses of prerigor- and postrigor-filleted cod and found that prerigor-filleted cod had less water loss during storage and cooking and it had a firmer fillet.

Factors Influencing Texture

pH/Water Content

When the pH in raw cod muscle is low, the texture after cooking will become harder. This seems to be connected with reduced water-retention capacity. Low pH gives a reduction in water holding, resulting in a drier texture in fillets of farmed cod. Freezer storage also seems to have an effect on the texture when the pH is low, giving a reduction in water-retention capacity and firmer fillets. Sensory tests show that farmed cod has a firmer and drier texture than wild cod (Landfald et al., 1991). Cod that is starved has a high pH post-mortem and the water content is reduced. This probably contributes to the soft texture of cooked starved wild cod (Love et al., 1974).

Size

For wild cod it has been shown that large fish are generally firmer in texture than small fish even with the same pH. In addition the pH is often lower in large fish than in small fish, with the result that the relative firmness of large fish will increase further. The significance of size, pH-ratio and water-retention capacity is not unambiguous, and with little food available, size is not of such great importance for texture (Love et al., 1974).

Colour

The colour of seafood is what first meets the customer and often determines whether the customer buys the product or not. For cod, therefore, it is important for the fillet to be as light, or white if you like, as possible. Fish muscle has both translucent and reflective properties. These change during different chemical and physical treatments. Factors such as water and fat content, contraction of musculature, pigments and not least coagulation of protein will influence colour and reflection of light. In non-oily fish such as cod, the musculature consists mainly of proteins and water. Proteins are large complex molecules, and physical stimuli such as heating or chemical exposure of salts, acids or bases will cause the proteins to be denatured. Different proteins react differently to the various types of stimulus. Denatured muscle proteins usually have less ability to hold water, appearing hard and opaque, making the muscle look whiter. The colour of wild cod will vary throughout the year and seems to be closely linked to the fish's nutritional status, geographical variations, myoglobin content and swimming activity. The farmed cod seems to have a tendency to become grey/chalky in colour, while wild cod had a tendency to become yellowish. In their experiments, Landfald et al. (1991) came to the conclusion that farmed cod was whiter after cooking than wild cod.

When performing sensory measurements of colour, it is important to take into account the fact that the colours are influenced by their immediate surroundings. Colour measurement should therefore be carried out under the most standardised conditions possible, such as by using light boxes like those developed by Skretting (Salmon colour box). By using instrumental measurements, the problem of people's limited colour vision is avoided. An instrument measures colour under the same conditions every time, thereby providing objective and quantitative measurements for colour of fish flesh. It is important to have a correlation between sensory and instrumental evaluation of lightness. Instrumental colour measurement is based on the same principle as the opponent colour vision in man, where each colour can be divided into the components redness, yellowness and lightness. This method is based on CIE (Commission International de l'Eclairage) (1976), L* a* b* colour system, where L* indicates lightness, a* red colour and b* yellow colour. The CIE colour system is used mainly on salmon, but is also employed on cod since no standardised method exists for measuring the colour of cod fillet. AKVAFORSK, Norway (The Institute of Aquaculture Research) has developed a method in which digital image analysis is used to obtain values for colour, pigment and fat content in salmon. Colour measurement by means of digital image analysis has also been tested on cod with good results.

Smell

Smell is the perception of volatile low-molecular compounds, and fresh fish gives off a fresh seaweed smell, which becomes less intense during storage before disappearing completely. Detection of smell is dependent on several factors, where temperature during storage and cooking and the amount of the various volatile compounds are critical. The smell of fresh fish is due to carbonyl compounds and alcohols with six, eight and nine carbon atoms (1-octane-3 ol, 1.5-octadien-3ol and 2.5-octadien-1ol). Other smells will arise later, producing a strong smell of bad fish. The smell of bad fish is due to a great extent to decay of trimethylamine oxide (TMAO), which is found in marine organisms. TMAO is the most studied of the NPN components and the decay product trimethylamine (TMA) is used as an indicator of freshness (taste and smell). TMA is formed by facultative anaerobic bacteria reducing TMAO to TMA. The further decay via IMP (inosine monophosphate) gives an end product such as H₂S and formaldehyde which contribute to the characteristic smell of bad fish. One of the inventors carried out an informal questionnaire among Norwegian fishmongers where the conclusion was that smell was the quality property to which the greatest importance was attached. It is known in the art that non-oily fish such as cod contains more TMAO than oily fish such as salmon.

Taste

There are four known tastes; sweet, salty, sour and bitter and these are produced by non-volatile low-molecular, such as H⁺, Cl⁻, Na⁺, amines and aldehydes. It is these substances, separately or together, that create what is perceived as taste and smell. In fish the taste-promoting substances are mainly IMP (inosine monophosphate), GMP (guanine monophosphate) and MSG (monosodium glutamate). IMP and hypoxanthine (Hx) are the decay product from ATP. The bitter taste is due to hypoxanthine (Hx), and the fact that fish that is placed in cold storage loses flavour is connected with IMP and Hx. A reduction in IMP content leads to loss of flavour, while formation of hypoxanthine gives the fish an “old” taste. Sensory evaluations of farmed cod and wild cod showed that there was a difference in taste and smell between the two (Landfald et al., 1991). The smell of farmed cod is described in the art as acidulous and the evaluation of smell and taste resulted in a lower total score for farmed cod (Losnegard et al., 1986).

Additives

An additive is defined as “a substance that is added in order to have a positive effect on the product's properties or an effect on the actual product”. Each additive is assigned an E-no. (EU number) which identifies the product, where E 500 is the designation for sodium bicarbonate (soda). Additives are used in foodstuffs in order to increase shelf life, nutritional value and range of uses or to facilitate processing.

The use of additives is strictly controlled by means of regulations. For example, the use of additives to conceal spoiled or contaminated food is prohibited. Many additives occur naturally in various organisms and plants, such as for example vitamins, dyes and antioxidants. The additives which are relevant to the present invention are acids and bases.

Acids

Lactic acid (CH₃—CHOH—COOH), acetic acid (CH₃COOH) and citric acid (C(OH)(CH₂CO₂H)₂ CO₂H) are some of the many different acids that are used as additives in foodstuffs. The most important reasons for using these are the ability they have to buffer solutions, and the fact that they act as an antioxidant and flavour enhancer.

Acidic solutions according to the invention may also include cultures of lactic acid bacteria.

Citric Acid

Citric acid or 2-hydroxy-1,2,3-propane tricarboxylic acid, (C(OH)(CH₂CO₂H)₂ CO₂H, pKa₁=3.15, pKa₂=4.77, pKa₃=5.19) is a weak acid found in citrus fruit. Many metals are naturally bonded to different components in food. When they are released by hydrolytic or other reactions, it is the metal ions that are released and participate in reactions. This may lead to discolouring, oxidation, smell and taste changes in food. By adding citric acid or one of its derivatives, these will react with the metal ions, forming stable complexes and thereby stabilising or preventing different reactions in food.

Citric acid is an approved additive, E 330, and is used as a flavour enhancer and preserver in food and drink, and for preventing bacterial growth (Fennema, 1996). Citric acid is described as an antioxidant, acidity regulator and anticoagulant. Citric acid is an important component in the citric acid cycle and is therefore a natural part of the metabolism of all organisms.

Bases

Basic (alkaline) substances are used in a number of different foodstuffs and processes, principally as a buffer and pH-regulator. Other functions may be as a colour and smell promoter or to influence the solubility of proteins. Sodium bicarbonate (NaHCO₃, soda) and sodium hydroxide (NaOH, lye) are examples of basic additives used in foodstuffs.

Sodium bicarbonate (Soda)

Soda (NaHCO₃) is an approved additive, E 500, and is used as an alternative to yeast in baking. It is used in ice cream and sweets, and occurs naturally in mineral-rich springs. Soda is also used as an acid-neutralising agent.

It has been shown that substantial water loss in connection with cold storage, freezing/thawing and cooking influences firmness, taste and yield in fish products. It is also known in the art that the consumers prefer cod, for example, to be as white as possible in its flesh. Consequently, there is a need for a method of treatment that gives light fish flesh while at the same time the flesh is firm in texture, has a good smell and juicy taste and good keeping quality.

It is the object of the present method to provide a treatment method that results in fish flesh with the above-mentioned qualities. This object is achieved with the present method, characterised by what will be apparent in the attached claims.

The present method comprises treatment of fish flesh whereby the flesh is first exposed to a basic solution and thereafter possibly an acidic solution, where the pH-values in the solutions are basic and acidic respectively in relation to the fish's normal pH-range, i.e. higher than approximately 7 and lower than approximately 6. If the fish flesh is only exposed to a basic solution, it may subsequently be rinsed with a suitable salt solution in order to provide a lower pH-value in the surface parts of the piece of fish flesh. The fish flesh is preferably exposed to solutions which are respectively basic relative to the fish's normal pH-range (>approximately 7) and acidic relative to the fish's normal pH-range (<approximately 6).

According to one aspect of the invention the pH-value in the basic and acidic solutions respectively is higher than approximately 7, preferably 8-9, and lower than approximately 6, preferably 1.5-3.

According to another aspect of the invention the exposure is performed by the fillet being submerged in basic and acidic baths, sprayed with basic and acidic solutions, or injected with basic and acidic solutions, or a combination of these exposure methods.

According to a further aspect of the invention the exposure is performed by the fillets being submerged in basic and acidic baths, where the basic and acidic additives are approved for foodstuffs, for example where the base is NaHCO₃ (E 500) and the acid is C₆HSO₇ (E 330).

According to yet another aspect of the invention the exposure times for the pieces of fish flesh in basic and acidic solution respectively are chosen with regard to the size of the piece of fish, with the result that the exposure times increase with the size/volume.

According to another aspect of the invention the exposure times are from at least 1 minute up to 3 days, preferably at least 12 hours in basic solution and from at least 2 seconds (dipping) up to 10 minutes in acidic solution.

According to another aspect of the invention the exposure time in basic solution is selected from 1 min to 60 min and the exposure time in acidic solution is selected from 2 sec (dipping) to 10 min for a fillet measuring approximately 3 cm×approximately 3 cm×approximately 2 cm.

According to yet another aspect of the invention the fish flesh originates from bony fish, defined as fish with white flesh. The fish is preferably selected from wild or farmed cod, more preferably farmed cod.

According to a further aspect of the invention the method is automated, the fillets being transported between the baths on a conveyor belt and lowered into the baths by means of gripping devices, or automatically sprayed or injected with the respective solutions.

Another aspect of the invention also involves a plant for treatment of the fish flesh according to the method, consisting of devices for exposing the fish flesh to basic and acidic solutions respectively, such as baths, spray devices and injection devices, packing devices, in addition to transport devices for transporting the flesh to the various treatment stations.

According to another aspect of the invention the fish flesh is treated according to the method, and the pH-value in the surface parts of the fish flesh is lower than the pH-value in the internal parts of the fish flesh.

According to a further aspect of the invention the fish flesh is white, while being firm, dry and having a good taste and smell.

The invention will now be explained in greater detail and illustrated by means of attached examples, which in no way are intended to limit the scope of protection determined by the attached claims.

### FIGURES

The examples are illustrated by means of the following figures:

FIG. 1. Dividing and measuring points for cod used in experiment 1. A to E indicate the pieces used for the various bath treatments. ▾=measuring point for pH. O=measuring point for texture and X=measuring point for image analysis of lightness.

FIG. 2. Dividing and analysis points for cod used in experiment 2. ▾=measuring point for pH, O=measuring point for texture and X=measuring point for lightness by means of Minolta Chromameter.

FIG. 3. Dividing and analysis points for cod used in experiment 3. ▾=measuring point for pH. The letters A, B and C indicate how the fillet is divided up for treatment.

FIG. 4. L*, a*, b* colour system CIE (1976), where L*-value used in this task indicates the lightness/whiteness of the sample.

FIG. 5. Average number and standard error for sensorily evaluated firmness (A) (5=firm, 1=soft), smell (B) (5=rotten, 1=seaweed) and lightness (C) (8=white, 1=brown) of raw pieces of cod after bath treatment at different pH levels (n=5).

FIG. 6. Average number and standard error for dry matter percentage (A) and water loss during cold storage (B) of raw pieces of cod bathed in solutions with different pH levels (n=5). Different letters indicate significant differences between the pH treatments (p≦0.05).

FIG. 7. Average number and standard error for instrumental lightness (L*-value) measured by means of image analysis of raw pieces of cod before and after bath treatment at different pH levels (n=5). Different letters indicate significant differences between the pH treatments (p≦0.05).

FIG. 8. Average number for instrumental measurement of firmness (N) by means of downward pressure (cylinder 12.5 mm diameter, 1 mm s⁻¹) on raw pieces of cod bathed in solutions with different pH levels (n=5). The instrumental measurements were performed by means of Texture Analyser (TA-XT2).

FIG. 9. Average number and standard error for pH-values measured on raw, prerigor-filleted cod (n=15) (A and B) and postrigor-filleted cod (n=21) (C and D) after bath treatment (C=control, S=soda C=citric acid). Different letters indicate significant differences between treatments within the filleting time (p≦0.05).

FIG. 10. Average number and standard error for firmness of raw, bath-treated, prerigor-filleted cod (n=15) and postrigor-filleted cod (n=21). (C=control, S=soda C=citric acid). Firmness was evaluated by finger pressure according to a points scale, where 1 is a soft fillet and 5 is a firm fillet. Different letters indicate significant differences between treatments within the filleting time (p≦0.05).

FIG. 11. Average number and standard error for smell of raw, bath-treated, prerigor-filleted cod (n=15) and postrigor-filleted cod (n=21). (C=control, S=soda C=citric acid). Smell was evaluated by points, where 1 indicates seaweed smell while 5 is a rotten smell. Different letters indicate significant differences between treatments within the filleting time (p≦0.05).

FIG. 12. Average number and standard error for lightness of raw, bath-treated, prerigor-filleted cod (n=15) and postrigor-filleted cod (n=21). (C=control, S=soda C=citric acid). Lightness was evaluated according to a points scale from 1 to 8, where 1 is a brown colour, while 5 is a white colour in the fillet. Different letters indicate significant differences between treatments within the filleting time (p≦0.05).

FIG. 13. Average number and standard error for gaping in raw, bath-treated, prerigor-filleted cod (n=15) and postrigor-filleted cod (n=21). (C=control, S=soda C=citric acid). Gaping was evaluated according to a points scale from 0 to 5, where 0 is no gaping, while 5 is extreme gaping. Different letters indicate significant differences between the treatments within the filleting time (p≦0.05).

FIG. 14. Average number and standard error for gaping across (A) (transverse gaping) and along (B) (longitudinal gaping) a fillet of raw, bath-treated, prerigor-filleted cod (n=15) and postrigor-filleted cod (n=21). (C=control, S=soda, C=citric acid). Gaping was evaluated according to a scale 0 to 2, where 0 is no gaping and 2 is substantial gaping. Different letters indicate significant differences between treatments within the filleting time (p≦0.05).

FIG. 15. Average number and standard error for measurement of dry matter percentage. The analyses were performed on raw, bath-treated, prerigor-filleted cod (n=15) and postrigor-filleted cod (n=21). (C=control, S=soda, C=citric acid). Different letters indicate significant differences between the treatments within the filleting time (p≦0.05).

FIG. 16. Average number and standard error in analysis of water loss in raw, bath-treated, prerigor-filleted cod (n=15) and postrigor-filleted cod (n=21) by means of run-off in the case of cold storage. (C=control, S=soda, C=citric acid). Different letters indicate significant differences between the treatments within the filleting time (p≦0.05).

FIG. 17. Average values and standard error for analysis of water loss by centrifuging raw, bath-treated, prerigor-filleted cod (n=15) and postrigor-filleted cod (n=21). (C=control, S=soda, C=citric acid). Different letters indicate significant differences between the treatments within the filleting time (p≦0.05).

FIG. 18. Average number and standard error in lightness measurement (L*-value) of raw, bath-treated, prerigor-filleted cod (n=15) and postrigor-filleted cod (n=21) by means of a Minolta Chromameter. (C=control, S=soda, C=citric acid). Different letters indicate significant differences between treatments within the filleting time (p≦0.05).

FIG. 19. Average number for instrumental measurement of firmness (N) by means of downward pressure (cylinder 12.5 mm diameter, 1 mm s⁻¹) on the back of raw, bath-treated, prerigor-filleted cod (n=21) and postrigor-filleted cod (n=15) at different depression depths. The instrumental measurements were carried out by Texture Analyser (TA-XT2).

FIG. 20. Average number for instrumental measurement of firmness (N) by means of downward pressure (cylinder 12.5 mm diameter, 1 mm s⁻¹) on the tail of raw, bath-treated, prerigor-filleted cod (n=21) and postrigor-filleted cod (n=15) at different depression depths. The instrumental measurements were carried out by Texture Analyser (TA-XT2).

FIG. 21. Average number and standard error for sensory evaluation of firmness (A) and dryness (B) of cooked, bath-treated, prerigor-filleted and postrigor-filleted cod (n=15). (C=control, S=soda, C=citric acid) according to a points scale from 1 (soft/dry) to 5 (firm/juicy). Different letters indicate significant differences between treatments within the filleting time (p≦0.05).

FIG. 22. Average number and standard error for sensory evaluation of smell (A) and tastiness (B) of cooked, bath-treated, prerigor-filleted and postrigor-filleted cod (n=15). (C=control, S=soda, C=citric acid) according to a points scale from 1 (old/bad) to 5 (fresh/good). Different letters indicate significant differences between treatments within the filleting time (p≦0.05).

FIG. 23. Average number and standard error for sensory evaluation of lightness of cooked, bath-treated, prerigor-filleted and postrigor-filleted cod (n=15). (C=control, S=soda, C=citric acid) according to a points scale from 1 (grey/yellow) to 5 (white). Different letters indicate significant differences between treatments within the filleting time (p≦0.05).

FIG. 24. Average number and standard error for instrumental lightness (L*-value) measured by image analysis of bath-treated, prerigor-filleted and postrigor-filleted cod before (A) and after cooking (B) (n-15). (C=control, S=soda, C=citric acid). Different letters indicate significant differences between treatments within the filleting time (p≦0.05).

FIG. 25. Schematic illustration of the different treatments (B12=12 g NaHCO₃/1; B25=25 g NaHCO₃/1; B50=50 g NaHCO₃/1; S12=12 g C₆H₈O₇/1; S25=25 g C₆H₈O₇/1; S50=50 g C₆H₈O₇/1; D=distilled water). N=pieces of cod per treatment, altogether 90 different combinations.

The present invention relates to a method for achieving optimal quality in fish flesh. Optimal quality is defined as improvement of the water-retention capacity, thus making the flesh juicier, as well as being light, firm and having good shelf life. These are all advantageous characteristics when the fish flesh has to be commercialized.

The present inventors have shown that exposing fish flesh to basic solution (pH 8-9) increases the flesh's water-retention capacity, while exposure to acidic solution (pH 1.5-3) makes the fish flesh light and firm. Exposure to basic solution alone provides no colour or odour benefits, in which case it will be necessary to rinse the flesh with distilled water. The present inventors then surprisingly discovered that by selecting optimal combinations between exposure of fish flesh pieces (approximately 3 cm×3 cm×2 cm) to basic solutions (1 minute to 12 hours) and exposure to acidic solutions (2 seconds (dipping) to 10 minutes), fish flesh was obtained that was juicy, light and firm in texture. The exposure times will be a function of the volume of the piece of fish flesh since the object is to raise the pH in the internal parts of the flesh relative to the fish's normal pH (6-7) and lower the pH in the surface parts. With reference to this object, the exposure time to basic solution also appears to be longer than the exposure time to acidic solution. The exposure process may be carried out by the fish flesh being lowered into baths consisting of basic and acidic solutions respectively, sprayed with the same solutions or injected with the same solutions. By using baths, for example, the exposure to basic solution can be undertaken overnight and the rest of the method implemented on the following day. In another embodiment the fish flesh is laid in basic solution immediately after it is cut and remains in the basic solution until rigor is gone, i.e. approximately 3 days. This facilitates cutting any bones out of the flesh.

The present method may also be suitable for automation, whereby, after being cut up and cleaned, the fish flesh is transported on a conveyor belt between different stations where they are submerged, sprayed or injected with basic and acidic solution respectively. For spraying and injecting, equipment is employed such as suitable nozzles and needles which are known in the art. After rinsing and drying, if appropriate, they may be transported to further processing, possibly a packing machine where packing and preparation for dispatch are undertaken.

The present invention also relates to a plant for treatment of the fish flesh according to the method. A plant of this kind will consist of devices for exposing the fish flesh to basic and acidic solutions respectively, such as baths, spray devices and injecting devices, a packing device, in addition to transport devices for transporting the flesh to the different treatment stations.

The method according to the present invention is directed to bony fish, preferably white fish which is defined as fish with white flesh.

Fish flesh comprises whole and cut-up fish fillets with and without skin, slices of fish and minced fish muscle.

The bases and the acids employed in the present invention are compounds that are approved as additives in foodstuffs. Examples of such compounds are sodium hydroxide, soda, lactic acid, acetic acid, citric acid and lactic acid bacteria culture. In addition to acidifying the surface layers of the fish flesh, citric acid, e.g., will give the product a fresh smell.

### EXAMPLES

Material and Methods

Fish Material

The material was prerigor and postrigor-filleted farmed cod (Gadus morhus L.) of different origins. The experiments were carried out at AKVAFORSK's laboratory, Ås, except for one where cod was treated directly at AKVAFORSK's experimental station on Averøy, Norway. All cod was slaughtered and prerigor-filleted at the different plants and sent to AKVAFORSK, Ås, where postrigor filleting was performed. This primary task was divided into three experiments in order to investigate the effect of different bath treatments—acidic bath (citric acid), basic bath (lye and soda) and neutral bath (distilled water) respectively—on the quality of fillets of farmed cod.

### Example 1

The experiments were conducted in February 2004. Five cod were delivered slaughtered and gutted from Fjord experimental station in Dønna, Norway on 20 Mar. 2003. This cod had been fed on dry feed. The cod were postrigor-filleted on 22 Mar. 2003 and placed in the freezer on the same day. These fish were kept in the freezer at −20° C. for 10 months. They were then thawed in a cold room at an average temperature of 2° C. and a variety of information on the cod was registered (table 1).

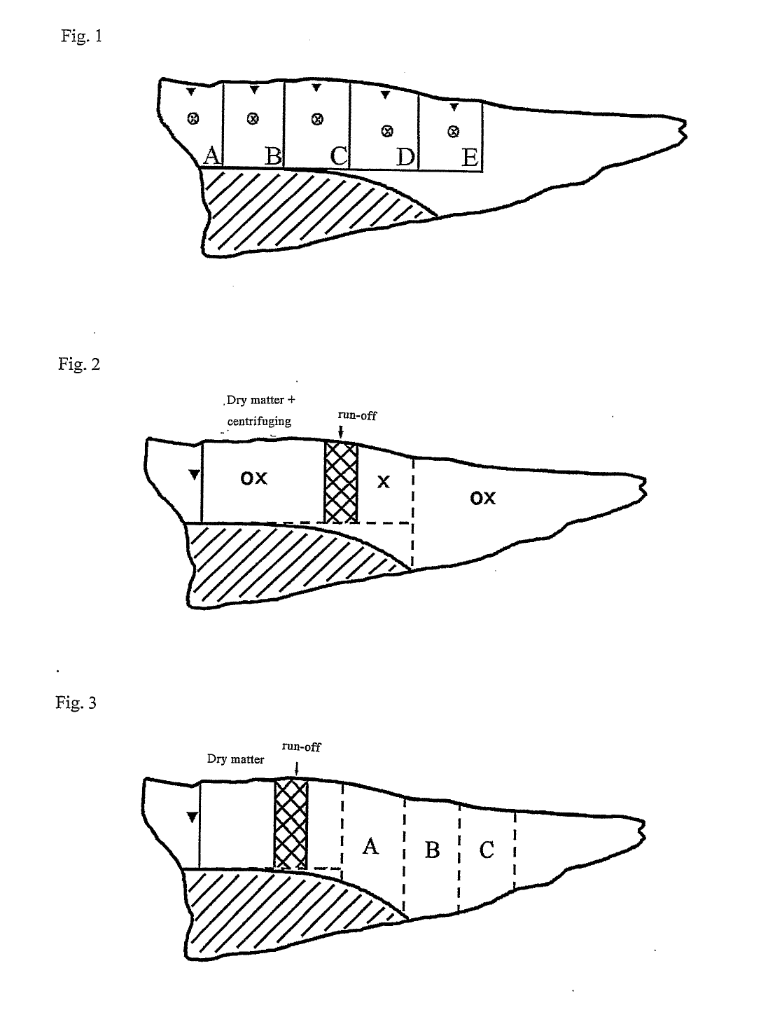

In example 1 five cod were used, divided into five pieces (FIG. 1), before quality evaluation (firmness, smell, colour and gaping), bath treatment and analyses (pH, dry matter, run-off, texture and image analysis) (table 4). For a description of the various bath treatments, quality parameters and analyses, see below. In order to avoid the effect of locality on fillets during the various bath treatments, the pieces of cod were randomised relative to the five different pH standards (attachment 2).

### Example 2

Experiment 2 was conducted from 4-12 Mar. 2003. 36 cod were slaughtered at Averøy, Norway. These cod had been fed on dry feed. The sea temperature at the removal point of the experiment was 5° C. All the cod were lifted from the experimental pens over to anaesthetisation basins. The anaesthetic used was Metakain (MS 222, 1.5dl/601 sea water). After anaesthetisation, the cod were bled by the gill arches at one side being severed, and after a bleeding time of 3-5 minutes the cod were killed by a blow to the neck. The cod were then put on ice and transported ashore. Some of the cod were far-advanced in the process of sexual maturity. Nine of the postrigor-filleted cod were starved.

The 36 cod were divided into two groups:
1. 15 prerigor-filleted cod (from the same pen) were divided into three groups of five fish.
2. 21 postrigor-filleted cod (from different pens) were divided into three groups of seven fish.

Group 1 with prerigor-filleted cod were gutted, filleted and skinned on Averøy, while cod that were to be postrigor-filleted were gutted, tagged and placed in plastic bags on ice, and transported to Ås for cold storage (average temperature 1° C.) for six days. Right-hand prerigor fillets were packed in bags and put on ice. Left-hand prerigor fillets were subjected to the bath treatment immediately on Averøy. A variety of information was recorded on both prerigor and postrigor-filleted cod (table 1).

Measurement of pH and temperature were carried out after bath treatment (measured at the neck end) (FIG. 2). Each fish was then sensorily evaluated for firmness, smell, colour and gaping (table 3). After bath treatment and registration, the left-hand prerigor fillets were packed in plastic bags, put on ice and transported to Ås for cold storage (average temperature 1° C.) for further analyses six days later. The various analyses (pH, run-off, dry matter and centrifuging) were measured on each fillet (FIG. 2 and table 4). Postrigor cod was filleted and skinned after six days. Left-hand postrigor fillet was subjected to bath treatment on the same day. Right-hand postrigor fillet was placed in the freezer at −20° C. for 12 months and then thawed at 2° C. Bath treatment, analyses and quality evaluation were performed in the same way for postrigor-filleted cod as for prerigor-filleted cod (FIG. 2 and table 4). For a description of the various bath treatments, quality parameters and analyses, see from page 16.

### Example 3

The experiments in example 3 were conducted on 11 Feb. 2004. Ten cod from Myre, Norway (Vesterålen cod) fed on fatty and lean wet feed were used in the experiment together with five cod from Bø (Finnmark cod) fed on capelin. The sea temperature on removal was 4.5° C. The anaesthetic employed was Benzokain (5 ml per 100 l sea water). The cod were slaughtered and gutted on 9. February. In this experiment the left-hand fillet was prerigor-filleted on 9 Feb. 2004, and the right-hand fillet was postrigor-filleted in Ås on 11 Feb. 2004 by the laboratory personnel at AKVAFORSK. The information on the fish was recorded as in experiments 1 and 2 (table 1).

15 cod were used and for each fillet, three pieces were cut off for bath treatment (FIG. 3.4). Bath treatment was the same as that in experiment 2 (table 2). The pH and quality (firmness, smell, colour and gaping) were recorded before bath treatment for both prerigor-filleted and postrigor-filleted cod (table 3, table 4). Pieces were cut off for dry matter analysis and run-off in the case of cold storage before bath treatment (FIG. 3.4). The pieces of cod that had undergone bath treatment were photographed for analysis of lightness before and after cooking. Cooking was carried out by the pieces of cod that had undergone bath treatment being placed in aluminium bowls and heat-treated in an oven at 85° C. for 10 min. The pieces of cod were then distributed for sensory tasting together with an evaluation form (attachment 9). Sensory tasting was performed by a random selection of people at the Department of Animal and Aquacultural Sciences (IHA), NLH and AKVAFORSK. For a description of the various bath treatments, quality parameters and analyses, see below.

TABLE 1
Recorded items and average values measured on cod used in the
various experiments.

| | | | Experiment |
|---|---|---|---|
| Recorded items | Experiment 1 | Experiment 2 | 3 |
| Round weight | 3.5 kg | 1.1 kg | 4.7 kg |
| Length whole fillet | 61 cm | 42 cm | 80 cm |
| Fillet weight | | | |
| Prerigor-filleted | | | 702 g |
| Prerigor-filleted Day 0 | | 187 g | |
| Prerigor-filleted Day 6 | | 176 g | |
| Postrigor-filleted | 847 g | | 678 g |
| Postrigor-filleted Day 6 | | 144 g | |
| Postrigor-filleted Freeze | | 145 g | |
| Fillet length | | | |
| Prerigor fillet length | | 23 cm | 42 cm |
| Postrigor fillet length | 43 cm | 22 cm | 44 cm |
| Gonad weight | 400 g | 630 g | 660 g |
| Liver weight | 420 g | 110 g | 340 g |
| Gender | x | x | |

Bath Treatment

In the different experiments cod fillets or pieces of cod were treated in baths in different solutions; one acid, one basic and one neutral (table 2).

In Example 1 citric acid powder was employed (C₆H₈O7 from E. Merck, Darmstadt, Germany) (M=192.3 g/mol) and sodium hydroxide (lye, NaOH from E. Merck, Darmstadt, Germany) (M=40.00 g/mol) dissolved in distilled water. These two compounds were mixed in different ratios in order to obtain solutions with the desired pH (pH 4 to pH 8) (attachment 1).

In Examples 2 and 3, citric acid powder (C₆H₈O₇) and sodium bicarbonate (NaHCO₃, soda) were employed dissolved in distilled water in order to obtain an acidic and a basic solution respectively (table 2). In all three experiments distilled water was used as control solution. Citric acid (E330) and soda (E500) were chosen since they are approved additives for use in food, they provide the desired pH in solution and can be purchased in any grocery store. The amount of the various additives, treatment time and pH-value of the solutions are shown in table 2.

TABLE 2
Bath treatments for cod used in experiments 2 and 3 and pH in the baths.

| | | Amount | Amount of | | | |
|---|---|---|---|---|---|---|
| | | of added | added citric | | | |
| | | soda, | acid, | | | |
| | | (NaHCO₃) | (C₆H₈O₇) | Time in | pH | pH |
| Treatment | Liquid | (E500) | (E330) | solution | experiment 2 | experiment 3 |
| Control | 2 l | | | 10 min | 6.7 | 6.8 |
| | distilled | | | | | |
| | water | | | | | |
| Soda | 2 l | 50 g per l | | 10 min | 8.08 | 8.12 |
| | distilled | | | | | |
| | water | | | | | |
| Citric acid | 2 l | | 50 g per l | 10 min | 1.95 | 1.83 |
| | distilled | | | | | |
| | water | | | | | |

Quality Parameters

Sensory Quality Parameters

Observations of the various quality parameters were recorded by the inventors alone, except in Example 3 where laboratory personnel at AKVAFORSK, Norway made the observations.

Firmness was evaluated by means of the finger method (a finger is pressed against the fillet) and was established according to the points scale in table 3. Smell was evaluated sensorily by smelling the cod fillet or pieces of fillet and quality was established according to the points scale in table 3.

Lightness measurement was conducted by the cod fillets or pieces of cod being placed in a Salmon colour box (T. Skretting, Stavanger, Norway) and an average of the whole fillet or the piece was evaluated visually according to the points scale in table 3. Gaping is defined as a gap in myocommata between two myotomes in the fillet, and was assessed on the basis of the points scale in table 3. Gaping along (longitudinal gaping) and across (transverse gaping) the fillet were evaluated by means of the points scale as illustrated in table 3.

TABLE 3
Table for determination of quality parameters

| Firmness, | 5 | | 4 | | 3 | | 2 | 1 |
|---|---|---|---|---|---|---|---|---|
| points | Firm | | | | Medium | | | Soft |
| Smell, points | 0 | | 1 | | 2 | | 3 | 4 |
| | Fresh | | | | Neutral | | | Rotten |
| Gaping, | 5 | | 4 | | 3 | | 2 | 1 |
| points | Disintegrated | | | | | | | Whole |
| Transverse | 0 | | 1 | | 2 | | | |
| and | None | | A little | | A lot | | | |
| longitudinal | | | | | | | | |
| gaping, | | | | | | | | |
| points | | | | | | | | |
| Lightness, | 8 | 7 | 6 | 5 | 4 | 3 | 2 | 1 |
| points | White | | Grey | | Yellow | | Brown | |

pH and Temperature

pH and temperature were measured in parallel. The measurements were conducted in the neck of whole fillets and in each individual piece (FIG. 3.5). pH was measured by means of a pH-meter 330i SET (Wissenschaftlich-Technische-werkstätten GmbH & Co. KG WTW, Weilheim, Germany), connected to pH-muscle-electrode (Schott pH-electrode, Blueline 21 pH, WTW, Weilheim, Germany). Temperature was measured by means of a temperature probe (TFK 325, WTW, Weilheim, Germany).

Sensory Evaluation by a Panel

Sensory evaluation was carried out on 11 Feb. 2004 by a random selection of people at the Department of Animal and Aquacultural Sciences (IHA), NLH and AKVAFORSK. The following quality parameters were evaluated according to a scale from 1 to 5: tastiness, firmness, dryness, smell and colour (attachment 9).

Instrumental Analyses

Instrumental Colour Measurement.

Instrumental colour measurement of cod in experiment 2 was conducted by means of a Minolta Chromameter (CR-200 Minolta, Osaka, Japan). The instrument was calibrated against a white standard (Skrede and Storebakken 1986). The colour was measured directly on the surface of the cod fillet at three places (FIG. 3.3). In experiments 1 and 3 instrumental colour measurements were conducted by means of digital image analysis (Photofish AS) both before and after treatment of the fillet in experiment 1 and before and after cooking in experiment 3.

The following parameter was measured:

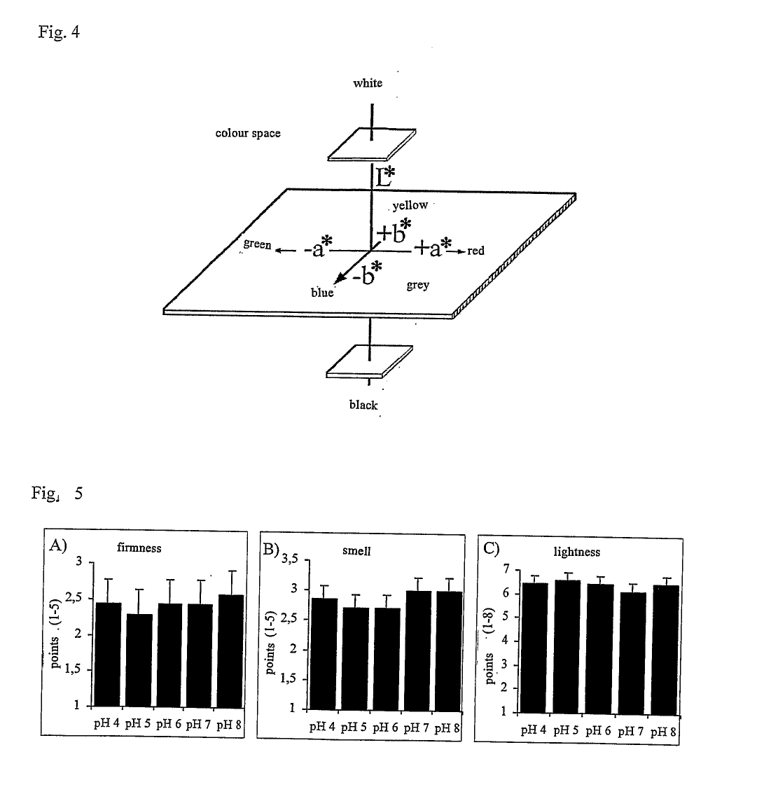

L*-value—which is a measurement of lightness where; 0=black and 100=white (FIG. 4).

Instrumental Texture Measurements

Texture in experiments 1 and 2 was measured by means of TA-XT2 Texture Analyser (SMS, Stable Micro Systems Ltd., Surrey, UK) at the Norwegian National College of Agricultural Engineering, Ås (FIG. 3.7A). This was equipped with a 5 kg load cell and a flat cylinder probe with a diameter of 12.5 mm (type P/0.5). The setting of the cylinder was fixed at 90% penetration at a speed of 1 mm/s. The cylinder probe was pushed down into the muscle and depending on the firmness, a pressure mark was left in the muscle. By means of the TA-XT2 Texture Analyser a three-dimensional measurement is obtained of force, distance and time. The TA-XT2 Texture Analyser was connected to a computer with the program Texture Export for Windows (version 1.22 Stable Micro), which displayed a curve for each measurement. This curve is called the TPA curve, Texture Profile Analysis (FIG. 3.7B). The analyses were conducted by means of Texture Expert for Windows.

In Example 1 the texture of the pieces of cod was measured at one location (FIG. 1). In Example 2 texture was measured at two locations on the fillet (FIG. 2).

Water-Retention

Dry Matter

In the three experiments, approximately 2 g of fish muscle was sliced off each fillet, cut into small pieces with scissors and weighed into small metal bowls. The bowls were then placed to dry at 105° C. for 18-24 hours. Both bowls and fish muscle were weighed before and after drying. After drying they were placed in a desiccator for cooling before being weighed again. Dry matter was calculated as a proportion of wet weight.

Calculation: Dry matter(%)=(weight of dried sample (g)/weight of weighed-in sample (g)*100

Run-off in the case of cold storage

Run-off was performed by a muscle sample of 10-15 g being sliced off the fillet. The sample was laid on a water-absorbent cellulose paper 8×11 cm (Absorber 1621304 supplied by the S-group ASA). Between the piece of fish and the cellulose paper, perforated nylon burlap was placed in order to prevent the sticky muscle from adhering to the cellulose paper. This was then placed in a zipper bag (14×8 cm) and the samples were placed in cold storage for 3 days (temp. approximately 2° C.), and liquid run-off was calculated by weighing the cellulose paper before and after storage. The paper was then dried in a hot cabinet. Water run-off was calculated as the part that evaporated during drying.

Calculation: Run-off(%)=(weight absorbent at start(g)−weight absorbent after run-off(g)/weight fish muscle(g)*100

Water loss during centrifuging

In experiment 2 approximately 15 g of fish muscle was weighed out and cut into small pieces by means of scissors. The sample was put into a 50 ml centrifugal tube. Filter paper type 589 Black ribbon ashless 185 mm in diameter was weighed, folded and laid on top of the muscle fibres, and in this case too a piece of perforated nylon burlap was placed between the fish muscle and the filter paper in order to avoid the muscle adhering to the paper. The sample was centrifuged for 10 minutes at 500 G and 10° C.. Minifuge RF (Heraeus Sepatech, Hanover, Germany) was employed. After centrifuging the filter was weighed and then dried in a drying cabinet for 18-24 hours at 50° C. before being placed in a desiccator. Finally, the dried filter paper was weighed.

Calculation: Total weight loss(%)=(filter after centrifuging(g)−filter after drying(g))*100/weight fish muscle

Data Processing

Processing of data was performed in Microsoft Excel 2000, SAS (Statistical Analysis System Institute, Inc. 1999) and Texture Expert for Windows (version 1.22 Stable Micro).

Excel was employed for processing data and graphs. “Statistical Analysis System” (SAS) was employed for statistical calculations. LSmeans (least squares method) was used in order to allow for variation in the data set, calculated by means of General Linear Model (GLM) based on type III sums of squares. GLM was employed in order to investigate whether there were significant differences between the different treatment methods with regard to quality properties, in addition to seeing the significance of the filleting time. The significance level was set at 5% (p<0.05).

Texture Expert was used for making TPA curves (Texture Profile Analyses curves) for each individual measurement.

A list of the quality parameters and analyses conducted on cod in the various experiments is given in table 4.

TABLE 4
Recorded items, quality parameters and analyses conducted on cod
in the three experiments.

| | Experi- | Experi- | |
|---|---|---|---|
| | ment | ment | Experiment |
| Recorded items | 1 | 2 | 3 |
| Sensory parameters | | | |
| Raw | | | |
| Firmness, points | x | x | x |
| Smell, points | x | x | x |
| Lightness, points | x | x | x |
| Gaping, points | x | x | x |
| Longitudinal gaping, points | | x | |
| Transverse gaping, points | | x | |
| Cooked evaluated sensorily | | | |
| Firmness, points | | | x |
| Smell, points | | | x |
| Lightness, points | | | x |
| Dryness, points | | | x |
| Tastiness, points | | | x |
| Instrumental measurements | | | |
| pH before treatment | x | | x |
| pH after treatment | x | x | |
| L*-value Minolta Chromameter | | x | |
| L*-value image analysis before treatm | x | | |
| L*-value image analysis after treatm. | x | x | x |
| L*-value image analysis after cooking | | | x |
| Firmness (Texture Analyser) | x | x | x |
| Analyses | | | |
| Dry matter, % | x | x | x |
| Run-off with cold storage, % | x | x | x |
| Centrifuging, % | | x | |

Results

### Example 1

pH Measurements of Raw Cod Fillets

The average pH in raw cod fillet before treatment was 6.18 and after treatment 6.22. The pH increased after treatment regardless of which bath treatment was employed. No significant difference was demonstrated between pH before and after treatment, or between the different pH-gradient treatments.

Sensory Evaluations of Raw Cod Fillets

Sensory evaluation of firmness, smell and lightness of raw fillets showed no significant differences between bath treatments (p>0.78). pH 4 and pH 8 achieved the highest value for firmness (FIG. 5A), but the difference was not significant between the different bath treatments. Fillet pieces bathed in solutions with pH 5 and pH 6 had a better smell and lighter fillet, but no significant difference was demonstrated (FIG. 5B-C).

Water-Retention Capacity in Raw Cod Fillets

Dry Matter

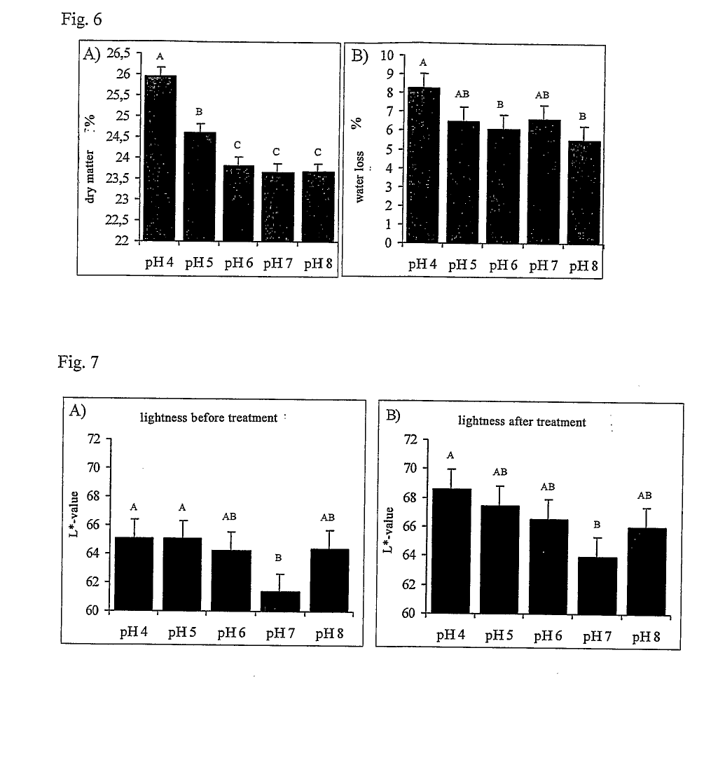

The dry matter content in the pieces of cod showed significant differences between the various pH treatments (FIG. 6A). Pieces of fillet bathed in pH 4 had the significantly highest dry matter content. Cod treated at pH 5 had significantly higher dry matter content than cod treated at pH 6, pH 7 and pH 8, which had the lowest dry matter content.

Run-off in the Case of Cold Storage

Run-off in the case of cold storage of raw, bath-treated pieces of cod showed the same tendency as the dry matter analysis. Pieces of cod treated at pH 4 had a significantly higher run-off than cod bathed in pH 6 and pH 8 (FIG. 6B).

Image Analysis of Lightness in Raw Cod Fillets

Pieces of cod bathed in solutions with pH 4 and pH 5 had a significantly higher L*-value than those treated at pH 7, and this applied both before and after bath treatment. pH 7-treated pieces of cod had the lowest L*-value (FIGS. 7A and 7B).

Instrumental Measurement of Firmness in Raw Cod Fillets

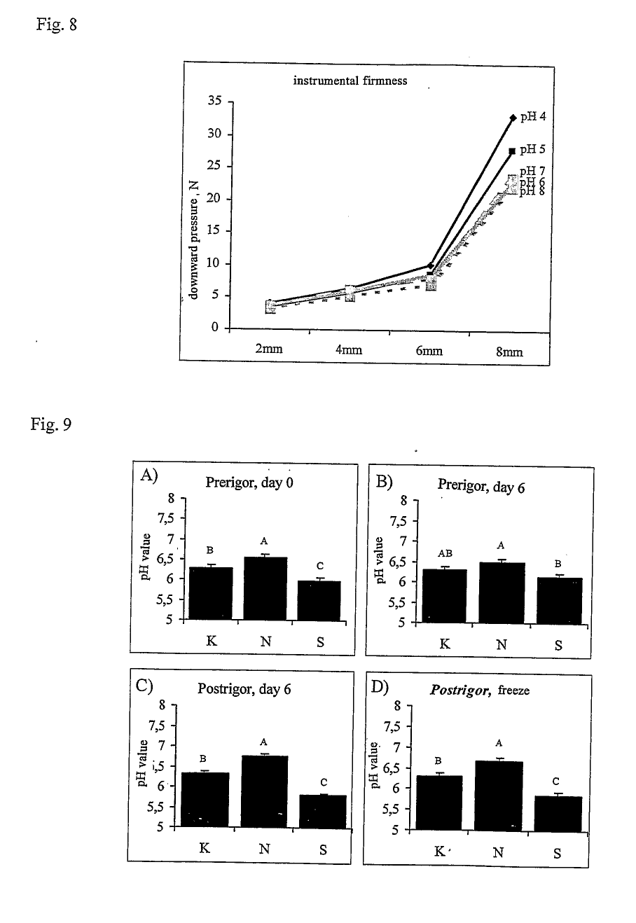

At 2 mm and 4 mm depression, no significant differences were demonstrated between the different bath treatments (FIG. 8, attachment 3). The force at 6 mm depression showed that the pieces of cod treated at pH 4 were significantly firmer than those treated at pH 8 (attachment 3). At 8 mm depression, pH 4 and pH 5-treated pieces of cod were significantly firmer than pieces of cod treated at pH 8 (attachment 3).

### Example 2

pH Measurements of Raw Cod Fillets

pH measured in cod immediately after slaughter was 7.28 on average. There were significant differences in pH between the different bath treatments, regardless of the filleting time (FIG. 9). Cod treated in a citric acid bath had the lowest pH (<6.2), while soda-treated cod had the highest pH (>6,5). No significant differences were demonstrated between prerigor- and postrigor-filleted cod (attachment 6).

Sensory Evaluation of Quality in Raw Cod Fillets

Firmness

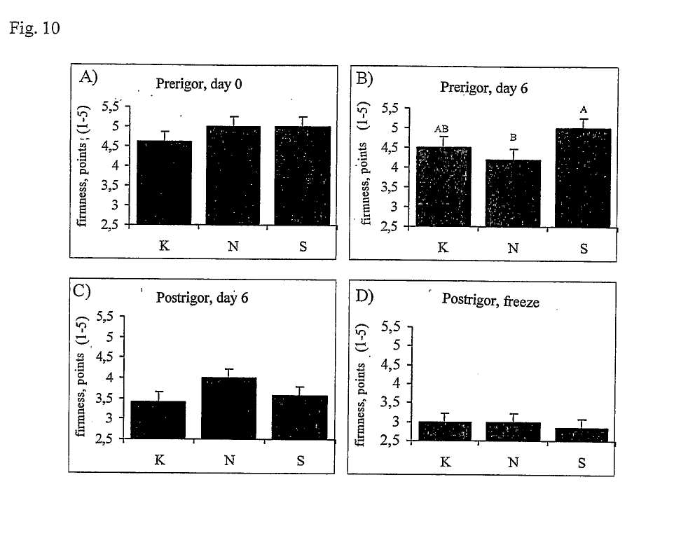

In the case of prerigor filleting on Day 0 and the two postrigor filleting times, there were no significant differences between the different treatments (FIG. 10A, C-D). Citric acid-treated cod obtained significantly higher points for firmness than soda-treated cod in the case of prerigor filleting on Day 6 (FIG. 10B).

Prerigor-filleted cod was significantly firmer than postrigor-filleted cod, and postrigor-filleted on Day 6 was firmer than frozen and thawed postrigor-filleted cod (attachment 6).

Smell

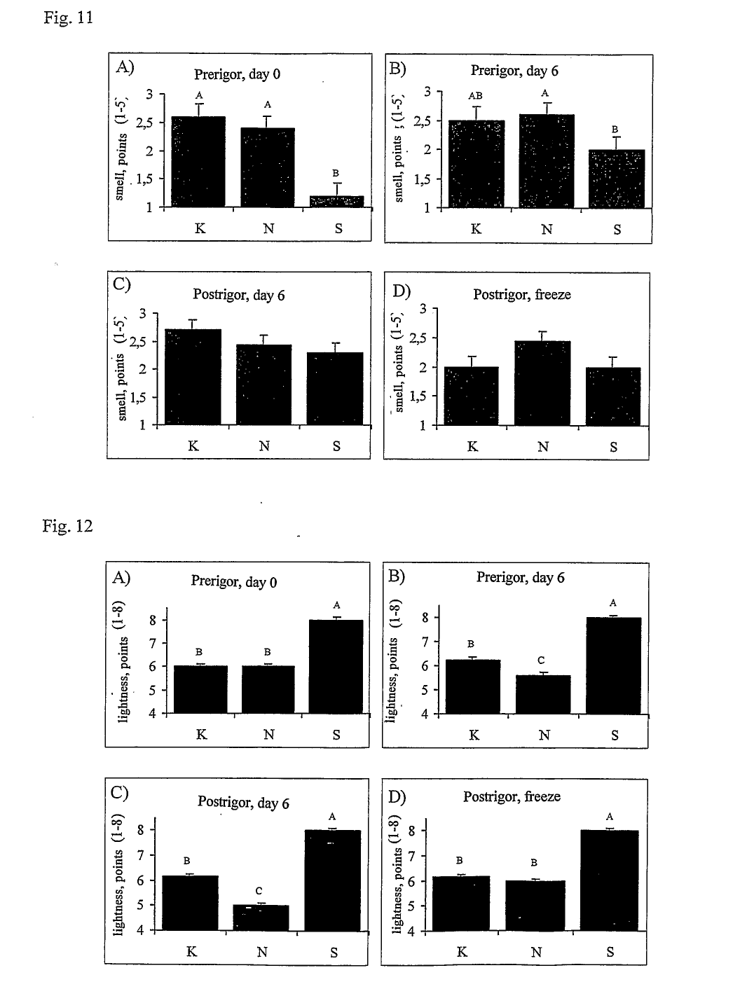

Citric acid-treated cod was judged to have a significantly fresher smell than soda-treated and control-treated cod in the case of prerigor filleting (FIG. 11A-B). No significant differences were shown between the various postrigor treatments (FIG. 11, C-D). No significant difference was found between prerigor-filleted and postrigor-filleted cod (attachment 6).

Lightness

Citric acid-treated cod achieved the highest points for lightness in all measurements, and was significantly different from soda-treated and control-treated cod, regardless of the filleting time (FIG. 12A-D). Soda-treated cod had the lowest points and was significantly different from control-treated cod (FIG. 12B-C). No significant difference was demonstrated between prerigor-filleted and postrigor-filleted cod (attachment 6).

Gaping

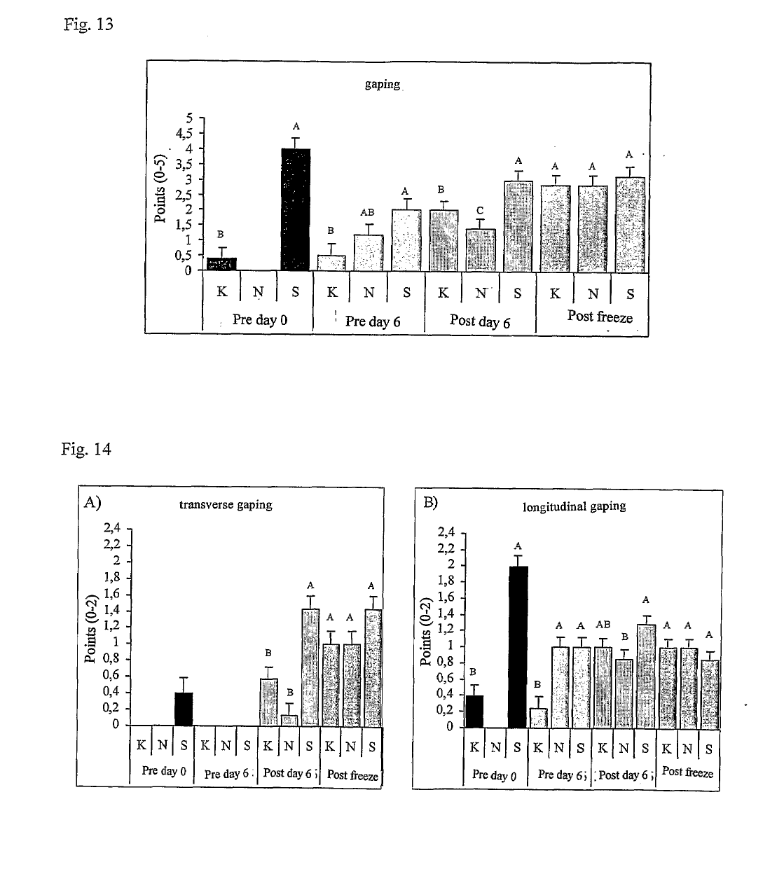

Fillet gaping showed significant differences between bath treatments (FIG. 13). Citric acid-treated cod had the highest degree of gaping, regardless of the time of treatment. Soda-treated cod had a lower proportion of gaping in the case of prerigor filleting on Day 0, and with postrigor filleting on Day 6 than control-treated cod. For postrigor fillets after freezing and thawing, soda and control-treated cod had a higher proportion of gaping than with prerigor filleting (attachment 6). Frozen and thawed postrigor fillets had a higher proportion of gaping and were significantly different from the three other treatment times (attachment 6). Prerigor-filleted cod on Day 6 had the smallest proportion of gaping and was significantly different from cod postrigor-filleted 6 days after slaughter.

Gaping Across the Fillet (Transverse Gaping).

Citric acid-treated cod had a higher proportion of gaping then soda-treated and control-treated cod for prerigor filleting on Day 0, postrigor-filleted on Day 6 and after freezing and thawing (FIG. 14A). Prerigor fillets had less gaping than postrigor fillets, regardless of the time of treatment (attachment 6).

Gaping Along the Fillet (Longitudinal Gaping).

Longitudinal fillet gaping showed significant differences between the different treatments (FIG. 14B). For the prerigor-filleted cod, citric acid treatment produced significantly more gaping than control treatment. For prerigor-filleted cod on Day 0 and postrigor-filleted cod on Day 6, there were significant differences between citric acid-and soda-treated fillets. No significant differences were found between prerigor- and postrigor-filleted cod (FIG. 14C).

Water-Retention Capacity in Raw Cod Fillets

Dry Matter

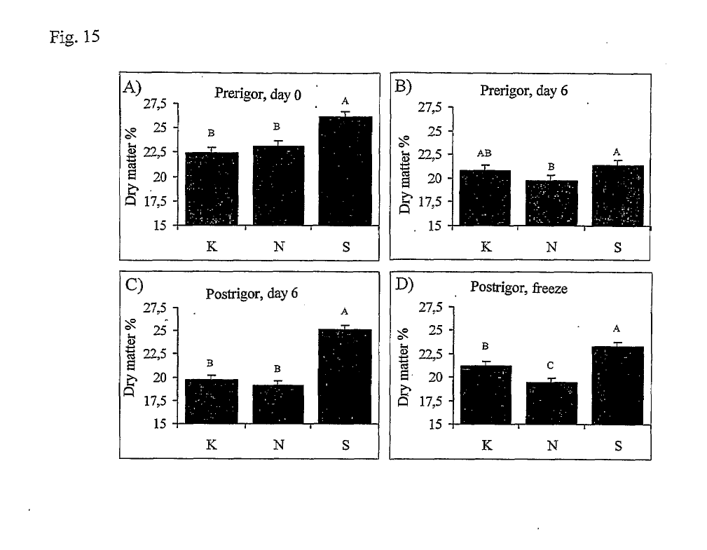

Significant differences in dry matter content were demonstrated between the different treatments. Citric acid-treated cod had significantly higher dry matter content than soda-treated cod, regardless of time of treatment (FIG. 15A-D). Except for prerigor-filleted cod on Day 6, control-treated cod had significantly lower amounts of dry matter then citric acid-treated cod (FIG. 15A, C-D). Frozen and thawed postrigor-filleted soda-treated cod had lower solid matter content than control-treated cod (FIG. 15D). Significant differences were demonstrated between prerigor-filleted and postrigor-filleted cod, where prerigor-filleted Day 0 had a higher dry matter content and was significantly different from the other filleting times (attachment 6).

Run-Off in the Case of Cold Storage

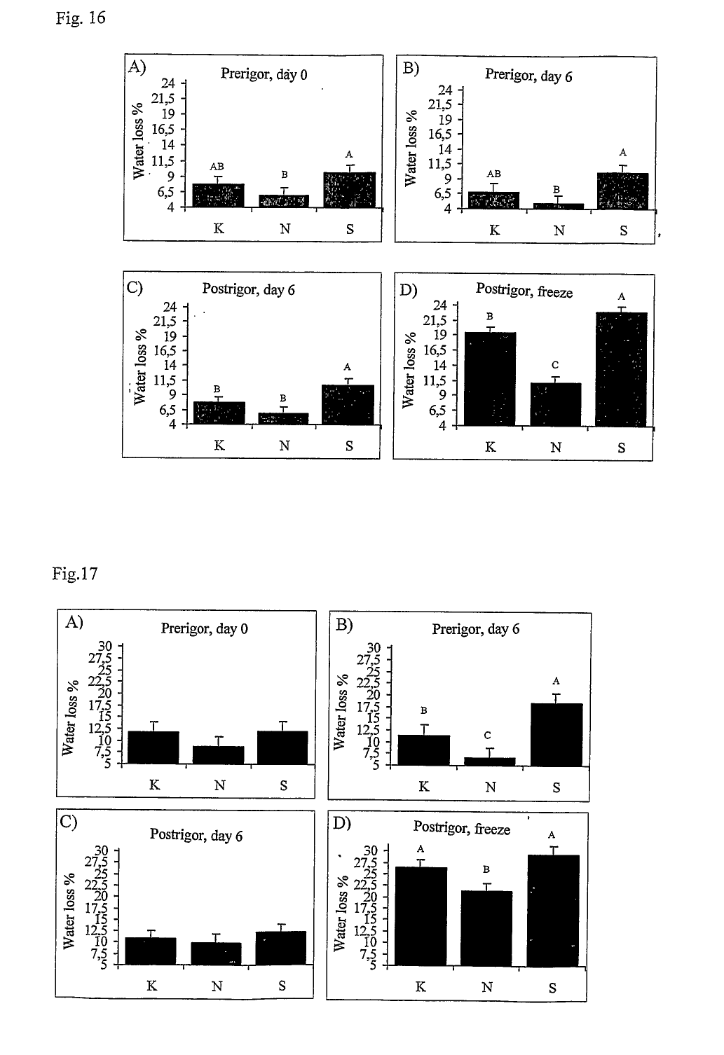

Citric acid-treated cod had the highest degree of run-off and was significantly different from soda-treated and control-treated cod (FIG. 16A-D). Soda-treated cod had the lowest water loss due to run-off. Frozen and thawed postrigor fillets had significantly the highest degree of run-off.

Water Loss During Centrifuging

Water loss during centrifuging showed significant differences between treatments at two times (FIG. 17B, D). Citric acid-treated cod had a higher water loss than soda-treated and control-treated cod in all four treatment times, but only at two times were soda-treated and citric acid-treated cod significantly different (FIG. 17B, D). For prerigor-filleted cod analysed on Day 6, citric acid-treated fillets had a significantly higher water loss than control-treated fillets (FIG. 17B). The water loss was significantly highest for postrigor fillets after freezing and thawing, regardless of bath treatment (attachment 6).

Instrumental Lightness Measured in Raw Cod Fillets

Lightness, Neck

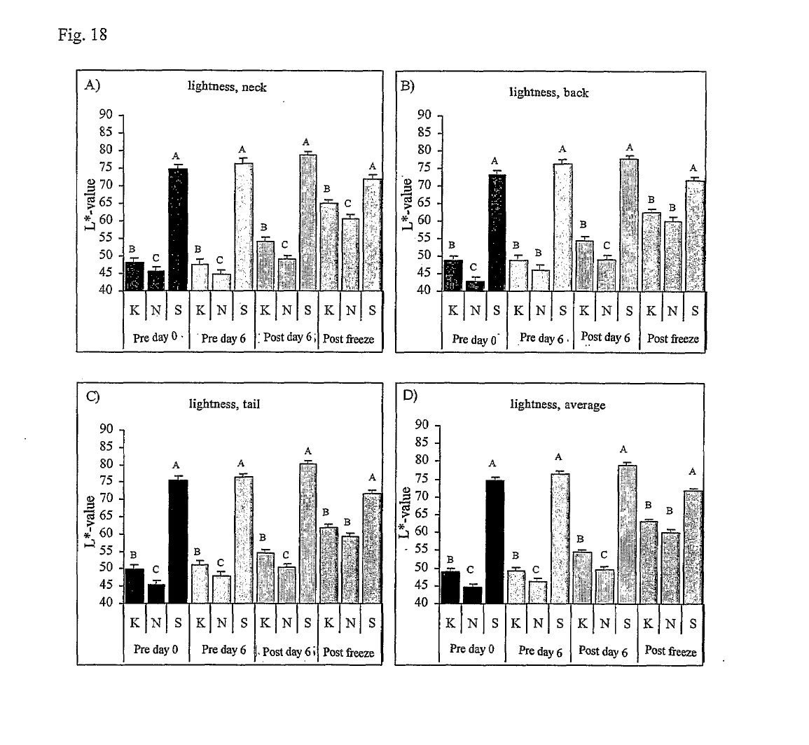

A significant difference was demonstrated between the different treatments, regardless of treatment time (FIG. 18A). Citric acid-treated cod had the highest L*-value and was significantly different from soda-treated cod which had the lowest L*-value at all treatment times. Frozen and thawed postrigor fillets had significantly higher L*-value than postrigor fillets analysed on Day 6. Postrigor fillets analysed on Day 6 had a significantly higher L*-value than prerigor fillets analysed on Day 0 and Day 6 (attachment 6).

Lightness, Back

The L*-value on the back showed a significant difference between treatments (FIG. 18B). Citric acid-treated cod had a significantly higher L*-value than soda-treated and control-treated cod. Soda-treated cod had the lowest L*-value and was significantly lighter than control-treated cod at the treatment times prerigor Day 0 and postrigor Day 6. Frozen and thawed postrigor-filleted cod had a significantly higher L*-value than prerigor-filleted cod on Day 0 (attachment 6).

Lightness, Tail

Measurement of L*-value at the tail showed a significant difference between the various treatments (FIG. 18C). Citric acid-treated cod had a higher L*-value than soda-treated and control-treated cod and was significantly lighter at all treatment times. Soda-treated cod had the lowest L*-value and was significantly different from control-treated prerigor-filleted and postrigor fillets analysed on Day 6. No significant difference was demonstrated in L*-value between prerigor and postrigor fillets of cod. However, there was a tendency to a difference between prerigor-filleted on Day 0 and postrigor-filleted frozen and thawed cod (p=0.07) (attachment 6).

Lightness, Average

Citric acid-treated cod had the highest L*-value and soda-treated cod the lowest L*-value in all measurements (FIG. 18D). Frozen postrigor fillets had significantly higher L*-value than prerigor fillets analysed on Day 0 (attachment 6).

Instrumental Firmness Measured in Raw Cod Fillets

Back

Instrumental measurements of firmness showed that citric acid-treated cod was significantly firmer than soda-treated cod, regardless of treatment time. Except for prerigor fillets treated on Day 0, citric acid-treated cod was also significantly firmer than control-treated cod.

Prerigor Day 0

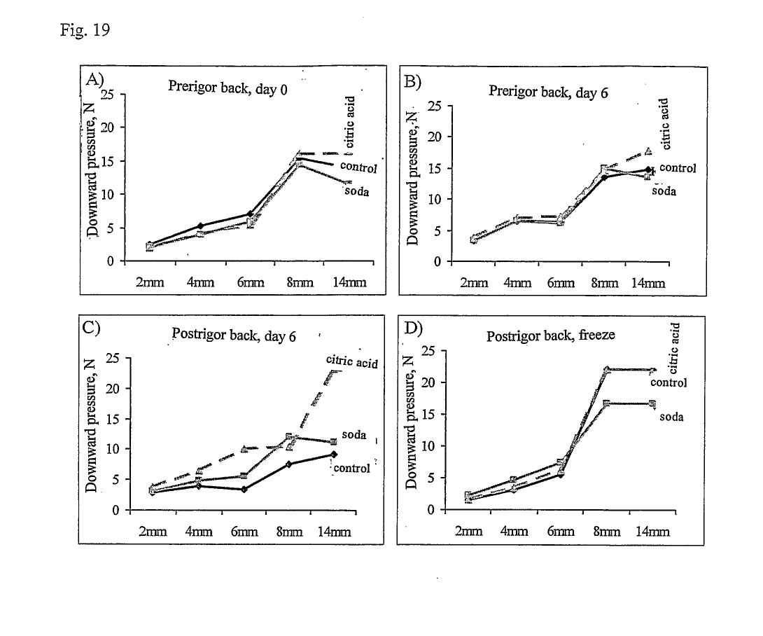

The force employed at 2 mm, 4 mm, 6 mm and 8 mm depression was not significantly different between the various treatments (attachment 4). At 14 mm depression, soda-treated cod had the least downward force and was significantly lower than citric acid-treated cod which had the greatest (FIG. 19A, attachment 4).

Prerigor Day 6

No significant differences were demonstrated between the various treatments until 14 mm depression, where citric acid-treated cod had the greatest downward force and was significantly different from soda-treated and control-treated cod (FIG. 19B, attachment 4).

Postrigor Day 6

At 2 mm and 8 mm depression, there was no significant difference between the various treatments. For 4 mm depression, control-treated cod had significantly less resistance than citric acid-treated and soda-treated cod. The resistance was significantly higher for citric acid-treated cod than for soda-treated and control-treated cod at 6 mm and 14 mm depression (FIG. 19C, attachment 5).

Postrigor Freeze

The force at 2 mm, 4 mm and 6 mm depression was highest for soda-treated cod. At 8 mm and 14 mm, control-treated and citric acid-treated cod had significantly the greatest force on downward pressure (FIG. 19D, attachment 5). The same value is recorded for 8 mm and 14 mm depression.

Comparison of Filleting Times

The force at 2 mm and 4 mm showed that prerigor-filleted cod on Day 6 had higher resistance to downward pressure than postrigor-filleted cod. At 6 mm depression no differences were demonstrated between prerigor-filleted and postrigor-filleted cod. At 8 mm and 14 mm depression frozen and thawed postrigor-filleted cod had higher resistance than prerigor-filleted cod. Citric acid-treated postrigor-filleted cod on Day 6 had the highest resistance of all treatment times at 14 mm. Control-treated and citric acid-treated frozen and thawed postrigor-filleted cod had equally high resistance at 8 mm and 14 mm. The same value is recorded for 8 mm and 14 mm depression (attachment 6).

Tail

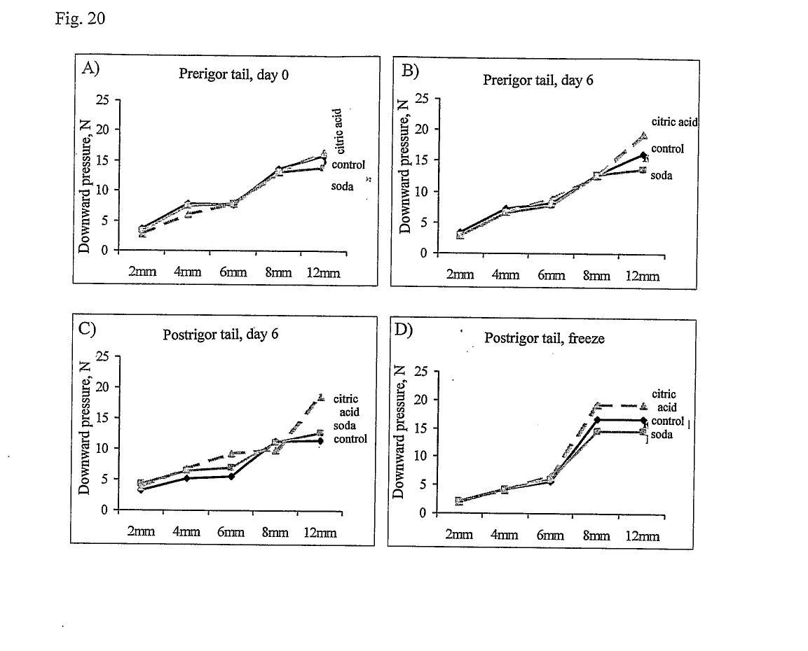

Citric acid-treated cod had greater force on downward pressure for all the treatments regardless of filleting time Soda-treated cod had the lowest degree of firmness measured in three of four treatment times (FIG. 20A-B, D).

Prerigor Day 0/Prerigor Day 6/Postrigor Freeze

No significant differences were demonstrated between the various treatments (FIG. 20A-B, D, attachment 4).

Postrigor Day 6

At 2 mm depression soda-treated cod had significantly higher resistance than control-treated cod. Citric acid-treated cod had significantly higher resistance for 4 mm, 6 mm and 12 mm depression than control-treated cod. The force at 8 mm showed no significant difference between the treatments (FIG. 20C, attachment 5).

Comparison of Filleting Times

A significant difference was demonstrated between prerigor-filleted and postrigor-filleted cod at all filleting times. At 2 mm, 4 mm, 6 mm and 8 mm, frozen and thawed postrigor-filleted cod had least force on downward pressure and was significantly different from the other filleting times. At 2 mm and 6 mm, postrigor-filleted cod on Day 6 had less force on downward pressure and was significantly different from prerigor-filleted cod on Day 6, and at 8 mm a tendency was seen to difference between these two times (p=0.06). At 4 mm, prerigor-filleted on Day 0 had greater force on downward pressure and was significantly different from both the postrigor-filleting methods. At 8 mm, postrigor-filleted cod on Day 6 had least force on downward pressure and was significantly different from prerigor-filleted cod on Day 0. At 12 mm, there was a significant difference between prerigor-filleting and postrigor-filleting, but not within the same filleting time (attachment 6).

### Example 3

Analyses of Raw Cod Fillets

Prerigor-filleted cod had a higher pH than postrigor-filleted cod before treatment. On sensory measurement of firmness, prerigor-filleted cod had greater firmness and was significantly different from postrigor-filleted cod (table 5). Postrigor-filleted cod had significantly higher points on evaluation of lightness than prerigor-filleted cod. Smell, gaping, dry matter and run-off in the case of cold storage showed no significant differences between prerigor-filleted and postrigor-filleted cod (table 5).

TABLE 5
Average number, standard error (SEM) and p-value for quality
parameters measured in raw, untreated cod, filleted prerigor or postrigor
(n = 15). Different letters indicate significant differences between prerigor-
filleted cod and postrigor-filleted cod.

| Parameters | Prerigor | Postrigor | SEM | p-value |
|---|---|---|---|---|
| pH | 6.34^{a} | 6.28^{b} | 0.04 | 0.041 |
| Firmness, | 3.6^{a} | 2.6^{b} | 0.15 | <0.001 |
| points | | | | |
| Smell, points | 1^{a} | 1^{a} | 0 | — |
| Lightness, | 5.2^{b} | 6.5^{a} | 0.29 | <0.001 |
| points | | | | |
| Gaping, points | 2.6^{a} | 2.6^{a} | 0.15 | 0.57 |
| Dry matter, % | 19.7^{a} | 19.9^{a} | 0.38 | 0.61 |
| Run-off, % | 12.7^{a} | 11.8^{a} | 0.93 | 0.15 |

Sensory Evaluation of Cooked Cod

Firmness

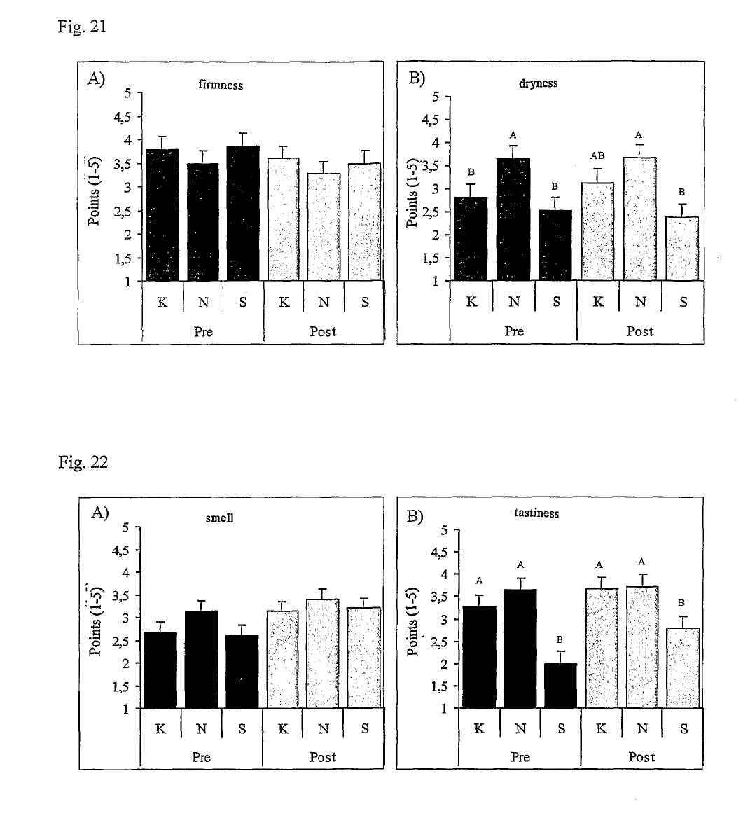

There were no significant differences in firmness between the treatments, either for prerigor-filleted or postrigor-filleted cod (FIG. 21A, attachments 7, 8).

Dryness

Soda-treated cod was judged to be significantly juicier than citric acid-treated and prerigor-filleted control-treated cod (FIG. 21B, attachment 7). No significant difference was demonstrated between prerigor-filleted and postrigor-filleted cod (attachment 8).

Smell

There were no significant differences in smell between the various treatments (FIG. 22A, attachments 7, 8). Prerigor-filleted cod was judged to have a fresher smell than postrigor-filleted cod (attachment 8).

Tastiness

There were significant differences in tastiness of cod, evaluated sensorily for the various treatments (FIG. 22B). Soda-treated cod had significantly more points for tastiness than citric acid-treated cod (FIG. 22B, attachment 7). No significant difference was demonstrated between prerigor- and postrigor-filleted cod.

Lightness

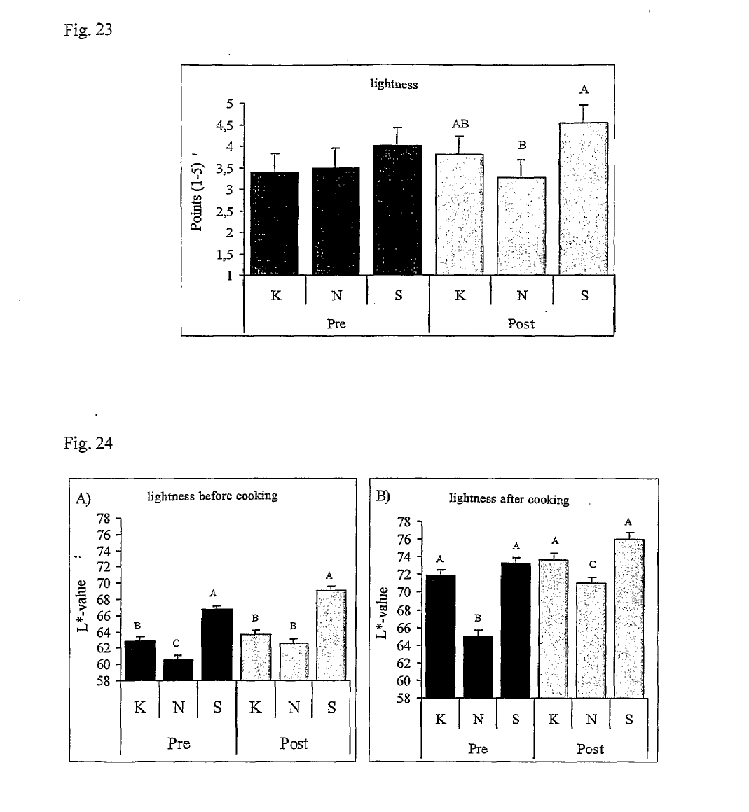

Sensory evaluation of lightness showed no significant differences between the various treatments of prerigor-filleted cod. Citric acid-treated cod was judged to be significantly lighter than soda-treated cod in the case of postrigor filleting (FIG. 23, attachment 7). Postrigor-filleted cod received a higher point score for lightness than prerigor-filleted cod, regardless of treatment (attachment 8).

Instrumental Lightness in Cod Before and After Cooking

Image analysis of lightness (L*-value) in bath-treated cod before cooking (FIG. 24A) and after cooking (FIG. 24B) showed significant differences between the various treatments. Citric acid-treated cod had the highest L*-value when measured before and after cooking, and was significantly different from prerigor-filleted and postrigor-filleted soda-treated cod (FIG. 24A-B). Prerigor-filleted control-treated cod was significantly different from citric acid-treated cod before cooking (FIG. 4.20A). Soda-treated cod had the lowest L*-value before and after cooking, and was significantly different from postrigor-filleted control-treated cod (FIG. 24A-B). Postrigor-filleted cod was measured at a higher L*-value than prerigor-filleted cod both before cooking and after cooking (attachment 8).

Discussion

pH

The pH in the cod fillets before bath treatment varied from 6.18 to 6.34, with an average of 6.27. The postrigor-filleted cod had a pH that was lower than or equivalent to that of the prerigor-filleted cod. These are values that were within the range known in the art. pH measured immediately after slaughter was 7.3 (ex. 2).

Bathing pieces of fillet in solutions with varying pH (pH 4 to pH 8) produced no significant change in pH (experiment 1). Bathing whole fillets in sodium bicarbonate (NaHCO₃, soda), citric acid (C₆H₈O₇) or distilled water produced significant differences in pH between the treatments (experiment 2). Fillets bathed in citric acid obtained the significantly lowest pH (pH=5.81), while the pH was highest for fillets bathed in soda (pH=6.75). Fillets bathed in distilled water obtained a pH of 6.3 (experiment 2). The pattern was the same for prerigor and postrigor fillets and between fresh and frozen fillets. Nevertheless, there was a tendency for the pH changes after bathing to be greater for postrigor fillets than for prerigor fillets. In experiment 3 the pH was only measured in fillets before treatment. The average pH in experiment 3 was 6.31.

The differences in pH observed in the various experiments may have several causes, including the size of the fish, age, degree of sexual maturity, nutritional status and bath treatment time. In experiment 2 several cod were sexually mature. This may have had an effect on pH before treatment. After treatment no differences were found between sexually mature and sexually immature fish. Cod used in these experiments varied greatly in length and weight, and this affected the thickness of the fillets. The same treatment time was employed regardless of fillet thickness. Different fillet thickness has probably had an influence on the extent to which the solution penetrated the fillet during bath treatment. In experiment 1, large cod (3.5 kg) was used with thick fillets (>24 mm), and there was little change in pH (0.04 pH units on average) after bath treatment. This indicates that a treatment time of 10 minutes was not sufficient for a greater change in pH in thicker fillets, or that the pH in the bath solutions was not low enough to produce the same effect as in thin fillets. In experiment 2 a smaller cod was employed (1.1 kg) with thinner fillets (≈15 mm) than in experiments 1 and 3. This may explain the marked pH change, since the solution is exposed to a relatively larger part of the fillet. In addition, the acidic solution in experiment 2 had lower pH (pH<2) than the most acidic solution in experiment 1 (pH 4). We have found no literature showing corresponding external acidic/basic treatment of fish.

Water-Retention

Water-retention capacity in cod fillets was measured by three different analytical methods: dry matter content and run-off in the case of cold storage in all three experiments, in addition to centrifuging in ex. 2.

In ex. 1 postrigor-filleted cod was used which had been placed in cold storage (−20° C.) for 10 months. After bath treatment the pieces of fillet had diminishing water loss during cold storage with increasing pH. The pieces of fillet treated at pH 4 had the greatest water loss (average 8.4%) and a dry matter content of 25.9%. At pH 8, the pieces of fillet had an average water loss of 5.5% and a dry matter content of 23.7%. This is the same as was found in experiment 2, but in this case the differences were even more sharply defined. Fillets treated in citric acid solution had the greatest average water loss during cold storage and centrifuging of 13.5% and 18.0% respectively. Soda-treated fillet had the lowest water loss during cold storage (6.7%) and centrifuging (10.7%). Dry matter content in citric acid-and soda-treated fillet was 23.9% and 20.4% respectively. Control-treated fillet finished up between these two with a water loss of 10% and a dry matter content of 21%.

In example 2 postrigor-filleted cod had an average higher water loss than prerigor-filleted, particularly postrigor-filleted cod that had been frozen for 12 months. Denaturing of protein may also be significant, since frozen and thawed postrigor-filleted cod may have had more denaturing than prerigor-filleted cod, and thereby greater water loss. It is probably freezer storage and possibly other factors that produce this effect in this experiment and not the filleting time.

In example 3 water-retention was measured in raw, untreated, prerigor- and postrigor-filleted cod. It had a water loss during cold storage of 12.6% and a dry matter content of 19.8%. This agrees with the measurements conducted on control-treated fillet in experiment 2. No differences were found in dry matter content and water loss due to run-off between prerigor- and postrigor-filleted cod in experiment 3. This is different from the findings of Liaklev (2003), where prerigor-filleted cod had better water-retention capacity than postrigor-filleted cod.

There are probably several factors that influenced the water-retention capacity in the cod, but results from these experiments showed a close correlation between low pH and reduced water-retention capacity.

Firmness

Firmness was measured sensorily and instrumentally. The differences were more clearly demonstrated when using instrumental measurement than by sensory evaluation.

In ex. 1 sensory measurement showed no difference between the various bath-treated pieces of fillet. Instrumental measurement established a significant difference between the treatments. Pieces of fillet bathed in solutions with low pH (pH 4 and pH 5) had firmer fillets than pieces of fillet bathed in solutions with high pH (pH 7). Cod treated in basic solution in experiment 1 appears to acquire a softer fillet.

Ex. 2 produced a similar result. In the case of sensory evaluation, no significant differences were found between the various bath treatments, with the exception of prerigor-filleted cod on Day 6, which was treated and analysed 6 days after slaughter. In this case the citric acid-treated cod was firmer than soda- and control-treated fillet. With instrumental measurement of firmness, there were significant differences between the treatments. Soda-treated fillet had the lowest resistance to downward pressure and had softer fillets than citric acid-treated and control-treated cod. One explanation for citric acid-treated cod being generally firmer is that low pH leads to denaturing of protein and lower water content. There are also factors other than pH that are important for the water-retention capacity. In this study the fillet thickness varied between the three experiments. This will have an influence on how far the various solutions will penetrate into the fillet.

In ex. 2, sensory evaluation showed that prerigor-filleted cod had firmer fillets than postrigor-filleted cod. Instrumental measurement showed that frozen and thawed postrigor-filleted cod had a higher degree of firmness than fresh prerigor- and postrigor-filleted cod. This shows that cold storage as conducted in this experiment will give a tougher fillet with firmer texture.

Ex. 3 also exhibited the same trend. Citric acid-treated fillet was firmer than soda-treated fillet. Taste evaluation of cod in experiment 3 showed that citric acid-treated cod had a firmer and drier fillet. This agrees with the prior art, where low pH has given a cod with reduced water-retention capacity, and rancid, hard and tough texture after storage and cooking. This is not what the consumers want.

The difference between the sensory and the instrumental evaluations can be explained by the fact that the former are subjective and will vary from person to person on the basis of each individual's preference. Firmness, after all, is a quality parameter which is difficult to describe on the basis of instrumental measurements. It is often the whole taste experience that is important when judging firmness (Chamberlain et al. 1993).

Dryness

Dryness was measured sensorily in experiment 3. Soda-treated fillet was judged to have a juicier consistency than citric acid-treated and control-treated fillet. This can be viewed in association with the fact that soda-treated cod had a higher pH and water content in the fillet after treatment. The high pH also helps to improve the water-retention capacity and this gives a juicier cod after cooking. Only 15 fish were examined and the results show that filleting time has no influence on sensory perception of dryness.

Gaping

In experiment 1 gaping was evaluated in raw, untreated fillets. The results showed that postrigor-filleted cod had a higher proportion of gaping than prerigor-filleted cod.

Gaping was evaluated after treatment in ex. 2. Citric acid-treated fillet had a higher proportion of gaping than soda-and control-treated cod at most treatment times, which probably is linked to variation in pH. For soda- and control-treated fillet the proportion of gaping increased with an increase in storage time. After cold storage there was little difference between the various treatments with regard to the proportion of gaping.

In ex. 2 postrigor-filleted cod had a higher proportion of gaping after treatment than prerigor-filleted. The greatest extent of gaping occurred in frozen and thawed postrigor-filleted cod and in citric acid-treated prerigor-filleted cod on Day 0. The latter may be due to the substantial drop in pH from 7.28 to 5.99 in the fillet. Such a large drop in pH results in substantial denaturing of protein and causes connective tissue to be more easily broken down. Prerigor-filleted cod shrinks up to 20% from its original size, giving a firmer fillet and less gaping.

Smell

The fillets treated in all the experiments had a fresh smell, regardless of treatment and filleting time. This shows that there were no particularly foul-smelling decay substances present in any of the fillets. In these experiments it was shown that treatment in different pH solutions had an effect on smell, but the results were not unambiguous.

In ex. 1 pH 5 and pH 6 had the best smell. The differences between the various pH treatments, however, were small and statistically insignificant.

After bath treatment in ex. 2 it was citric acid-treated fillet that had the best smell. Within the filleting times it was prerigor-filleted cod on Day 0 and cold-stored postrigor-filleted cod that received the highest points for smell. That cold-stored postrigor-filleted cod received higher points than fresh cod can be explained by the fact that the degradation of TMAO was more advanced in fresh cod prerigor- and postrigor-filleted on Day 6.

In ex. 3 it was postrigor-filleted soda-treated cod that was judged to have the best smell. Postrigor-filleted citric acid-treated and control-treated cod had approximately the same smell, and slightly better than prerigor-filleted cod with the same treatment. The difference between prerigor-and postrigor-filleted cod was not significant in any of the experiments, but it looks as if postrigor filleting gives a slightly better smell.

Taste

Taste was only tested in experiment 3, where postrigor-filleted, soda-treated cooked cod had the best taste according to the test panel. A fillet with high pH will probably be juicier on account of higher water content than fillet with low pH, and this agrees with the results in these experiments (see above).

Prerigor-filleted citric acid-treated fillet was judged to have the worst taste by the test panel, while control-treated fillet received on average good points regardless of filleting time. The test panel commented that citric acid-treated fillet had a sourer taste than they were used to. At the same time it was judged to be drier. Postrigor-filleted cod achieved a better taste on average, but was not significantly different from prerigor-filleted cod. The postrigor-filleted cod had probably matured more, thereby acquiring a more characteristic fish flavour.

Lightness

It is known that consumers want the cod flesh to be as white as possible. Cod treated in citric acid (low pH) achieved the highest degree of whiteness in all the experiments, both with sensory evaluation and instrumental measurement.

In ex. 1 sensory evaluation of frozen and thawed postrigor-filleted cod did not show that low pH gave a lighter fillet. Fillet treated at pH 4 had approximately the same lightness as pH 8 in the case of sensory evaluation. With instrumental measurement, on the other hand, measurable differences in lightness were obtained. Cod fillet treated at low pH 4 had a higher average L*-value than cod bathed in solutions with pH 7 (L*-values of 69 and 63 respectively).

In ex. 2 fillets bathed in citric acid solution had the highest sensorily evaluated lightness (8 points for all treatments). The same applies to the instrumentally measured value (L*-value 75.3). It is reasonable to assume that low water-retention capacity, and therefore firmer muscle is the reason for the fillet becoming less translucent and looking lighter at low pH. Denaturing of protein will also be more extensive at low pH, thus contributing towards a lower water content and lighter fillet. Soda-treated cod had the lowest level of lightness both sensorily (5.7) and instrumentally (L*-value 51.8). High pH gives better water-retention and protein denaturing does not occur to such a great extent. The fillets can therefore become softer and more translucent, assuming a grey/yellow appearance. Control-treated cod was less light than citric acid-treated cod, but lighter than soda-treated cod (sensorily 6.0 and L*-value 53.9). In experiment 2 both prerigor- and postrigor-filleted cod were used. With sensory evaluation no difference was found between the filleting methods. Instrumental measurements, on the other hand, showed that prerigor-filleted cod had a lower L*-value (56.9) than postrigor-filleted cod (L*-value 62.9).

In ex. 3 similar results were found. With sensory evaluation citric acid-treated fillet was judged to be lighter (4.25 points of max. 5 points) than soda-treated (3.4 points) and control-treated fillet (3.6 points). The situation was the same with instrumental measurement where citric acid-treated cod obtained an L*-value of 67.9, while soda-treated and control-treated cod obtained L*-values of 61.6 and 63.3 respectively. When cooked the pieces of fillet bathed in citric acid obtained a higher degree of lightness than the other treatments, measured both sensorily and instrumentally.

In ex. 3 prerigor-filleted cod had a lower level of lightness before treatment (5.1 points from a possible 8) than postrigor-filleted cod (6.5 points). In the case of instrumental measurement too, before and after cooking, prerigor-filleted cod had a lower level of lightness (L*-value 63.4 and 70.3) than postrigor-filleted cod (L*-value 65.1 and 73.5). This is different from the findings of one of the inventors, where postrigor-filleted cod had a lower level of lightness than prerigor-filleted cod. This is explained by the fact that prerigor filleting produces a firmer muscle, less water holding and a less translucent surface, with the result that it is judged to be lighter.

### Conclusion After Examples 1-3

Effect of Bath Treatment

pH

Cod fillets bathed in different pH solutions have an influence on the final quality. Bathing fillets in citric acid gave on average a lower pH in the fillet than cod treated in solutions with higher pH, such as soda and distilled water (control solution). The filleting time had no influence on final pH after bath treatment.

Water-Retention Capacity

Fillets treated in citric acid solution had a consistently higher water loss than cod treated in soda or control solution. With regard to water loss, the best time for treatment is between Day 0 and Day 6 after filleting, both for soda- and citric acid-treated cod. It was these times that gave least water loss from the fillets. Treatment of frozen and thawed cod is not recommended, since it gives higher water loss regardless of treatment. The filleting time had no influence on water-retention capacity in farmed cod in this study.

Texture

Sensory analysis of cooked cod showed that bathing in the citric acid solution gave a firmer and drier fillet, while bath treatment in soda gave a softer and juicier fillet. The total taste experience was best for the fillets bathed in soda and worst for the fillets bathed in citric acid. Prerigor-filleted cod was judged to have a firmer fillet than postrigor-filleted cod.

Gaping

Soda treatment had a positive effect on gaping compared with control-treated cod. Citric acid treatment had a negative effect on gaping, particularly for fillets that were bathed immediately after filleting. For soda treatment it is most favourable to treat cod that is filleted prerigor.

Smell

On evaluation of the smell of raw, treated fillet, citric acid-treated cod consistently came out best. In experiment 3 soda-treated cod was judged to have the best smell after cooking and citric acid-treated cod the worst. With sensory evaluation of smell, no significant difference was shown between prerigor- and postrigor-filleted cod.

Lightness

Cod treated in citric acid solution had a consistently higher degree of lightness than the other treatment solutions. This applied to sensory and instrumental measurements. Soda-treated cod came out worst in both sensory and instrumental measurements and the fillets had a more grey/yellow colour. Postrigor-filleted cod had a consistently higher level of lightness than prerigor-filleted cod.

### Example 4

This example describes treatment of fish flesh according to the invention, where the fish flesh was first exposed to a basic bath and then exposed to an acid bath.

Material and Method

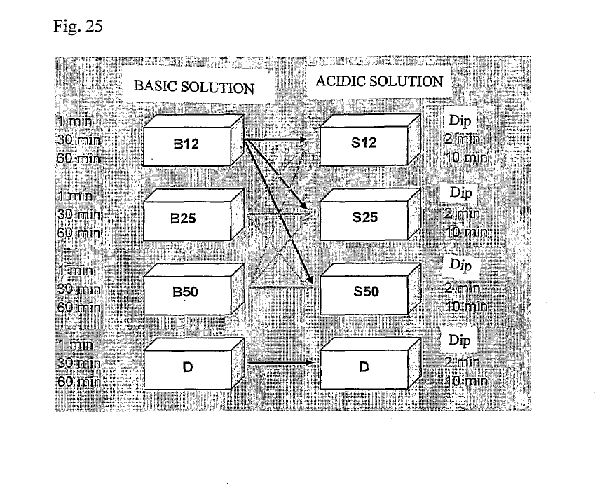

The fish used in the experiment were seven cod (Gadus morhua) which were raised from fry from AKVAFORSK's experimental plant on Averøy. The fish were slaughtered on Monday Jun. 19, 2006, gutted, packed on ice and sent to AKVAFORSK Ås for analysis. A description of the fish used in the experiment is given in Table 1. The cod was filleted at Ås on 23/6 and the fillet weight was recorded. The fillets were then divided into pieces of 3×3 cm. The treatments comprised: 1) bath in basic solution, 2) bath in acid solution. Three different concentrations of base (NaHCO₃) and acid (C₆H₈O₇) were employed and three different bath times (1 min, 30 min, 60 min for bath in basic solution and dip for 30 sec, bath for 2 min or 10 min). Distilled water was employed as control group. Altogether this gave 90 different combinations (Table 8 and FIG. 25). A survey of the progress of the experiment is given in Table 4.

TABLE 6
Weight and length of the cod used in the experiment

| | Length | Round weight | Gutted weight | Fillet weight |
|---|---|---|---|---|
| Fish 1 | 63 | 4460 | 3600 | 1172 |
| Fish 2 | 67 | 4840 | 3960 | 1232 |
| Fish 3 | 65.5 | 4745 | 3675 | 1059 |
| Fish 4 | 67.5 | 4485 | 3600 | 1015 |
| Fish 5 | 66 | 4175 | 3485 | 997 |
| Fish 6 | 67 | 5090 | 4230 | 1015 |
| Fish 7 | 68.5 | 4705 | 3740 | 1180 |

TABLE 7
Concentration of acid and base and pH for the solutions employed in
the experiment

| | | pH | |
|---|---|---|---|
| Citric acid | | | Citric acid, (C₆H₈O₇) (E330) |
| S12 | 12.5 g/l | 2.28 | |
| S25 | 25 g/l | 2.14 | |
| S50 | 50 g/l | 1.99 | |
| Soda | | | Soda, (NaHCO₃) (E500) |
| B12 | 12.5 g/l | 8.23 | |
| B25 | 25 g/l | 8.15 | |
| B50 | 50 g/l | 8.08 | |

TABLE 8
Treatments used (n = 3 pieces per treatment).

| | | BASE min | | | | | | | | |
|---|---|---|---|---|---|---|---|---|---|---|
| | | 1 | 1 | 1 | 30 | 30 | 30 | 60 | 60 | 60 |
| | | ACID min | | | | | | | | |
| | | DIP | 2 | 10 | DIP | 2 | 10 | DIP | 2 | 10 |
| S12 | B12 | A1 | A2 | A3 | B1 | B2 | B3 | C1 | C2 | C3 |
| S12 | B25 | A4 | A5 | A6 | B4 | B5 | B6 | C4 | C5 | C6 |
| S12 | B50 | A7 | A8 | A9 | B7 | B8 | B9 | C7 | C8 | C9 |
| S25 | B12 | D1 | D2 | D3 | E1 | E2 | E3 | F1 | F2 | F3 |
| S25 | B25 | D4 | D5 | D6 | E4 | E5 | E6 | F4 | F5 | F6 |
| S25 | B50 | D7 | D8 | D9 | E7 | E8 | E9 | F7 | F8 | F9 |
| S50 | B12 | G1 | G2 | G3 | H1 | H2 | H3 | I1 | I2 | I3 |
| S50 | B25 | G4 | G5 | G6 | H4 | H5 | H6 | I4 | I5 | I6 |
| S50 | B50 | G7 | G8 | G9 | H7 | H8 | H9 | I7 | I8 | I9 |
| D | D | J1 | J2 | J3 | K1 | K2 | K3 | L1 | L2 | L3 |

The combinations of letters (A-L) and numbers in the table indicate the treatment of 3 pieces of fish fillet, where each piece measured approximately 3 cm × 3 cm × 2 cm.
A1 to I9 show the different combinations of time in basic and acid solutions, with 3 different concentrations of base (50 g/l (B50), 25 g/l (B25), 12 g/l (B12)), and acid (50 g/l (S50), 25 g/l (S25), 12 g/l (S12)). J-L represent control experiments where the pieces of fillet were exposed to distilled water.

TABLE 9
Survey over which analyses were conducted and time

| | |
|---|---|
| 19/6-2006 | The cod was slaughtered on Averøy |
| 23/6-2006 | Filleting, dividing and weight |
| | registration of pieces (n = 270) and bath |
| | treatment. The pieces were placed on |
| | plastic trays with a cotton lining and |
| | placed in cold storage (3° C.) |
| 26/6 and 27/6 | Weight registration of the pieces, |
| | photographing for subsequent colour |
| | analysis (image analysis), texture |
| | measurement, pH measurement and |
| | preparation of analysis of dry matter and |
| | water-retention capacity. |
| 29/6 and 30/6 | Weight registration, water-retention |
| | capacity (weight of the mats on which |
| | the muscle samples were stored) |

Instrumental Texture Measurements

The texture analyses were conducted by means of TA-XT2 Texture Analyser (SMS, Stable Micro Systems Ltd., Surrey, UK). The measurements were carried out by pressing a flat cylinder (12.5 mm in diameter type P/0.5) into the muscle at a constant rate (1 mm/s). The analyses were conducted by means of Texture Expert for Windows. The height of the piece of muscle, the force (N) required to press the cylinder 90% into the muscle together with the area under the force-time curve (the total work, N*s) were recorded.

Measurement of pH

pH and temperature were measured in parallel. The measurements were conducted in each individual piece at the same point as the texture measurements. The instrument employed was a pH-meter 330i SET (Wissenschaftlich-Technische-Werkstätten GmBH & Co. KG WTW, Weilheim, Germany), connected to pH-muscle-electrode (Schott pH-electrode, Blueline 21 pH, WTW, Weilheim, Germany). Temperature was measured by means of a temperature probe (TFK 325, WTW, Weilheim, Germany).

Dry Matter

The amount of dry matter (%) in the samples was recorded as: (weight dried sample (g)/weight weighed sample (g))*100. The muscle (approx. 2 kg) was dried at 105° C..

Run-off in the Case of Cold Storage

The piece of muscle was weighed before treatment and after 3-days in cold storage (3° C.). During this period the muscle was placed on a plastic sheet lined with cotton. Weight loss (%) during storage was recorded. The muscle's liquid-holding capacity was also measured by placing a slice of approximately 10-12 g on a water-absorbent cellulose paper 8×11 cm (Absorber 161304 supplied by the S-group ASA). Between the piece of fish and the cellulose paper a piece of perforated nylon burlap was laid in order to prevent the sticky muscle from adhering to the cellulose paper. This was then placed in a zipper bag (14×8) and the samples were placed in cold storage for 3 days (temp. approx. 3° C.). Liquid run-off was calculated by weighing the cellulose paper before and after storage. The paper was then dried in a drying cabinet. Water run-off was calculated as the part that evaporated during drying (Mørkøre, 2002). Water run-off (%) was calculated as ((weight absorbent at start(g)−weight absorbent after run-off (g)/weight fish muscle(g))*100. After weighing they were dried and the amount of loss of fat and protein was estimated as ((weight absorbent at start(g)−weight absorbent after drying (g))/weight fish muscle(g))*100.

Smell

The smell of each piece of muscle was evaluated by five untrained judges according to a scale from 0-4. The sensory analysis was conducted three days after bath treatment.

| | | | | |
|---|---|---|---|---|
| 0 | 1 | 2 | 3 | 4 |

| | | |
|---|---|---|
| Fresh smell | Neutral smell | Stale smell |

Data Processing

The results from the texture analyses were corrected for variation in thickness of the muscle pieces and the results for liquid loss were corrected according to the day on which they were analysed. The corrections were performed with the use of the statistical program SAS. The mean values stated for texture and run-off are therefore LSMeans, while the results stated for the remaining parameters are uncorrected mean values. The results were sorted in Excel. The effect of treatment was analysed in SAS (ANOVA).

Results

All the parameters showed substantial variation between the treatments as illustrated in Tables 10-17. In order to find the optimal treatment of the muscle pieces in this model study, the results were sorted according to the following defined criteria:

Desired value

| | | |
|---|---|---|
| 1. | Liquid loss (%) after 3 + 3 days storage at 3° C. | <12% |
| 2. | Texture, area | 50-60 N * s |
| 3. | Lightness (L*-value) | 64-67 |
| 4. | Smell | <2 points |

Comments

1) Liquid loss <12% must be considered to be very low for muscle pieces of this size stored over such a long period. Such good water-retention capacity means that the juiciness is retained and the weight loss is low (it also has economic advantages). 2) The texture should be neither too soft nor too hard. For these muscle pieces, values between 50-60 N*s are considered to be optimal. 3) Lightness is an important quality criterion for cod, but if the values exceed approximately 67 for muscle like that tested, the flesh will look as if it is cooked, and that is not advantageous. 4) Fresh smell is another important quality criterion. The fish should smell fresh or neutral. The most advantageous is that the fish smells fresh.

The stated values are considered to be optimal for the muscle pieces in this study. Optimal values must be defined for the specific product tested. The results from this study, moreover, apply to bath treatment of muscle pieces of farmed cod measuring 13.5 cm³. The time in the bath must be optimised according to the volume of the muscle treated and the characteristics of the fish flesh (species, fish size, etc.). After having read the present application, a person skilled in the art will be able to determine a favourable combination of time in basic and acidic solutions.

The Bath Treatments which Surprisingly Gave the Best Overall Results were G7, E2 and E5

Thus the results of this study surprisingly show that it is possible to optimise the quality of the product by combining bath treatment in NaHCO₃ and C₆H₈O₇ solutions. It has previously been shown that pH is of great importance for the fish muscle's ability to hold liquid. This study, however, surprisingly shows that the strength of the solution of NaHCO₃ and C₆H₈O₇ per se also influences quality properties such as liquid-holding, smell, colour and texture—see table 7 which shows that there was relatively little difference in pH between the solutions of different concentrations of NaHCO₃ and C₆H₈O₇ respectively. The optimal concentration of the solutions must be optimised for the specific product that is being treated.

Liquid Loss

TABLE 10
Weight loss after 3 days storage at 3° C. (storage from day 0-3 after
filleting). The muscle pieces were weighed after filleting and then placed on a
plastic tray lined with cotton. The tray with muscle pieces was packed in plastic.

| | | BASE min | | | | | | | | |
|---|---|---|---|---|---|---|---|---|---|---|
| | | 1 | 1 | 1 | 30 | 30 | 30 | 60 | 60 | 60 |
| | | ACID min | | | | | | | | |
| | | DIP | 2 | 10 | DIP | 2 | 10 | DIP | 2 | 10 |
| S12 | B12 | 5.0 | 4.8 | 7.2 | 4.9 | 4.8 | 6.7 | 3.8 | 4.7 | 5.4 |
| S12 | B25 | 6.0 | 6.3 | 6.6 | 4.4 | 3.0 | 4.5 | 2.0 | 4.2 | 3.3 |
| S12 | B50 | 25.4 | 3.6 | 6.1 | 2.0 | 1.3 | 1.1 | 0.1 | 0.0 | 0.0 |
| S25 | B12 | 0.8 | 8.6 | 11.7 | 2.9 | 4.1 | 8.6 | 3.8 | 8.7 | 12.2 |
| S25 | B25 | 7.1 | 5.9 | 16.6 | 1.6 | 2.7 | 4.7 | 4.0 | 5.6 | 6.1 |
| S25 | B50 | 5.9 | 4.1 | 8.9 | 0.0 | 0.0 | 0.1 | 0.7 | 0.0 | 0.0 |
| S50 | B12 | 11.9 | 11.9 | 24.6 | 0.0 | 7.0 | 19.7 | 6.2 | 11.9 | 22.8 |
| S50 | B25 | 11.2 | 13.4 | 18.8 | 1.3 | 5.2 | 9.6 | 2.8 | 6.3 | 6.7 |
| S50 | B50 | 0.9 | 14.8 | 30.4 | 19.1 | 8.0 | 2.9 | 0.9 | 3.5 | 0.0 |
| D | D | 6.2 | 5.6 | 7.1 | 7.2 | 6.0 | 8.7 | 6.6 | 13.0 | 7.8 |

Statistical model: Total liquid loss = bath treatment,
p-value for the model = <0.0001

TABLE 11
Water loss after 3 days storage at 3° C. (storage from day 3-6 after
filleting). A slice of muscle with known weight was placed on a cellulose mat and
stored for three days before the mat was weighed again. The mat's weight
increase relative to the weight of the muscle piece was recorded as water loss.

| | | BASE min | | | | | | | | |
|---|---|---|---|---|---|---|---|---|---|---|
| | | 1 | 1 | 1 | 30 | 30 | 30 | 60 | 60 | 60 |
| | | ACID min | | | | | | | | |
| | | DIP | 2 | 10 | DIP | 2 | 10 | DIP | 2 | 10 |
| S12 | B12 | 11.1 | 9.5 | 12 | 9.9 | 8.6 | 10.7 | 10.8 | 11.2 | 8.5 |
| S12 | B25 | 8.8 | 11.3 | 12.4 | 12.9 | 9 | 9.6 | 9.4 | 9.7 | 9.6 |
| S12 | B50 | 9.6 | 11.5 | 10.7 | 9.1 | 7.3 | 10.1 | 7.7 | 7.8 | 9.3 |
| S25 | B12 | 10.6 | 12.5 | 14.4 | 9.4 | 6.9 | 9.8 | 9.9 | 8.9 | 11.7 |
| S25 | B25 | 12.8 | 11.7 | 13.4 | 10.6 | 8.1 | 12.4 | 12.8 | 11.8 | 12.6 |
| S25 | B50 | 10.6 | 11.9 | 11.7 | 8.5 | 8.6 | 9 | 10 | 8.1 | 10.7 |
| S50 | B12 | 10.5 | 13.8 | 21.9 | 7.8 | 9.1 | 12.4 | 12.1 | 9.8 | 22.8 |
| S50 | B25 | 12 | 15 | 19.2 | 9.2 | 9.2 | 11 | 10.4 | 10.2 | 9.9 |
| S50 | B50 | 10.9 | 8.6 | 24.3 | 10.3 | 8.8 | 10.2 | 11.9 | 7 | 8.4 |
| D | D | 12.4 | 11.8 | 13.2 | 10.7 | 10.3 | 11.9 | 10.7 | 9.2 | 11.3 |

Statistical model: Total liquid loss = bath treatment and date of analysis.
P-value for the model = <0.0001;
p-value treatment p < 0.0001:
p-value date p < 0.0001.

TABLE 12
Total weight loss after 6 days cold storage. The results include loss after
0-3 days (Table 5), loss after 3-6 days plus loss of fat/protein.

| | | BASE min | | | | | | | | |
|---|---|---|---|---|---|---|---|---|---|---|
| | | 1 | 1 | 1 | 30 | 30 | 30 | 60 | 60 | 60 |
| | | ACID min | | | | | | | | |
| | | DIP | 2 | 10 | DIP | 2 | 10 | DIP | 2 | 10 |
| S12 | B12 | 17.4 | 15.7 | 20.7 | 15.6 | 13.7 | 17.8 | 15.3 | 16.6 | 14.7 |
| S12 | B25 | 15.9 | 18.9 | 20.6 | 18 | 12.4 | 14.5 | 11.8 | 14.3 | 14.1 |
| S12 | B50 | 36.1 | 16.5 | 18.1 | 11.3 | 8 | 11.7 | 8.2 | 7.7 | 9.8 |
| S25 | B12 | 12.7 | 22.7 | 27.9 | 12.4 | 10.8 | 18.7 | 15.1 | 17.8 | 25.5 |
| S25 | B25 | 21.6 | 19.1 | 31.5 | 12.9 | 10 | 17.8 | 17.9 | 17.8 | 20 |
| S25 | B50 | 17.9 | 17.5 | 22.1 | 7.8 | 9 | 10 | 11.6 | 7.9 | 11 |
| S50 | B12 | 23.5 | 27.4 | 48.8 | 0 | 16.5 | 33 | 19.8 | 20.6 | 38.9 |
| S50 | B25 | 24.7 | 30.2 | 40.2 | 11 | 15.8 | 21.3 | 14.7 | 16.8 | 17.4 |
| S50 | B50 | 9.2 | 23.8 | 57.2 | 29.8 | 18.5 | 13.7 | 14.2 | 10.7 | 5.1 |
| D | D | 19.1 | 18.9 | 22 | 18 | 17 | 21.3 | 17.8 | 22.6 | 20.4 |

Statistical model: Total liquid loss = bath treatment and date of analysis
P-value for the model = <0.0001;
p-value treatment p < 0.0001;
p-value date p = 0.0001

Smell

TABLE 13
Smell evaluated by 5 judges. Fresh smell received 0-2 points,
stale smell 2-4 points. Score 2 = neutral.

| | | BASE min | | | | | | | | |
|---|---|---|---|---|---|---|---|---|---|---|
| | | 1 | 1 | 1 | 30 | 30 | 30 | 60 | 60 | 60 |
| | | ACID min | | | | | | | | |
| | | DIP | 2 | 10 | DIP | 2 | 10 | DIP | 2 | 10 |
| S12 | B12 | 2.0 | 2.0 | 1.9 | 1.6 | 1.2 | 1.6 | 1.8 | 2.2 | 2.1 |
| S12 | B25 | 1.6 | 1.8 | 1.8 | 1.5 | 2.0 | 1.8 | 1.4 | 1.9 | 1.6 |
| S12 | B50 | 1.9 | 1.8 | 1.7 | 2.0 | 1.8 | 2.2 | 2.3 | 2.0 | 1.9 |
| S25 | B12 | 1.6 | 2.1 | 1.5 | 1.9 | 1.8 | 1.8 | 2.2 | 2.2 | 1.7 |
| S25 | B25 | 2.0 | 2.0 | 1.5 | 1.9 | 1.5 | 1.9 | 2.0 | 1.9 | 1.9 |
| S25 | B50 | 2.0 | 1.7 | 2.2 | 1.6 | 2.1 | 1.6 | 2.3 | 2.3 | 1.9 |
| S50 | B12 | 1.8 | 2.1 | 1.7 | 1.8 | 1.6 | 1.9 | 2.3 | 1.9 | 1.7 |
| S50 | B25 | 2.0 | 2.1 | 2.2 | 2.0 | 1.9 | 1.9 | 1.7 | 1.6 | 1.6 |
| S50 | B50 | 1.7 | 1.8 | 2.1 | 2.0 | 1.7 | 1.8 | 2.5 | 2.3 | 1.6 |
| D | D | 2.0 | 1.9 | 2.0 | 1.8 | 1.9 | 1.8 | 1.9 | 1.8 | 1.6 |

Texture

TABLE 14
Firmness measured instrumentally (N * s).

| | | BASE min | | | | | | | | |
|---|---|---|---|---|---|---|---|---|---|---|
| | | 1 | 1 | 1 | 30 | 30 | 30 | 60 | 60 | 60 |
| | | ACID min | | | | | | | | |
| | | DIP | 2 | 10 | DIP | 2 | 10 | DIP | 2 | 10 |
| S12 | B12 | 37.9 | 58.1 | 37.9 | 49.6 | 40 | 39.6 | 53.1 | 46.1 | 60.8 |
| S12 | B25 | 46.9 | 48.6 | 70.5 | 39.5 | 46.7 | 60.4 | 54.9 | 38 | 62.6 |
| S12 | B50 | 53.1 | 46.8 | 58.6 | 36.9 | 67.8 | 48 | 86.1 | 58.8 | 61.7 |
| S25 | B12 | 43.1 | 53.2 | 59.1 | 50 | 51 | 39.4 | 48.8 | 32.8 | 40.2 |
| S25 | B25 | 26.8 | 31.4 | 52.1 | 41.1 | 55.4 | 40.4 | 41.6 | 43.5 | 62.2 |
| S25 | B50 | 52 | 50.5 | 41.5 | 56.7 | 65.1 | 44.2 | 43.1 | 45.2 | 68.9 |
| S50 | B12 | 50.5 | 41.3 | 54.1 | 36.1 | 45.5 | 31.9 | 34.4 | 58.3 | 42.2 |
| S50 | B25 | 47.4 | 45.6 | 46.7 | 39.5 | 43.9 | 52.5 | 47.4 | 48.9 | 59.8 |
| S50 | B50 | 55.4 | 63.1 | 38.2 | 42.5 | 70.8 | 45.7 | 33.6 | 35.3 | 63.1 |
| D | D | 34.9 | 35.2 | 42.2 | 47.3 | 49.5 | 39 | 41.3 | 40.2 | 29.9 |

TABLE 15
Lightness measured by image processing (L*-value).

| | | BASE min | | | | | | | | |
|---|---|---|---|---|---|---|---|---|---|---|
| | | 1 | 1 | 1 | 30 | 30 | 30 | 60 | 60 | 60 |
| | | ACID min | | | | | | | | |
| | | DIP | 2 | 10 | DIP | 2 | 10 | DIP | 2 | 10 |
| S12 | B12 | 64 | 63 | 63 | 62 | 61 | 63 | 62 | 63 | 62 |
| S12 | B25 | 62 | 61 | 62 | 64 | 61 | 61 | 62 | 61 | 64 |
| S12 | B50 | 58 | 62 | 63 | 62 | 60 | 60 | 61 | 61 | 59 |
| S25 | B12 | 64 | 65 | 66 | 61 | 64 | 66 | 63 | 62 | 65 |
| S25 | B25 | 65 | 66 | 68 | 61 | 64 | 61 | 63 | 65 | 65 |
| S25 | B50 | 61 | 60 | 66 | 62 | 60 | 63 | 58 | 59 | 60 |
| S50 | B12 | 62 | 69 | 73 | 61 | 66 | 68 | 61 | 66 | 67 |
| S50 | B25 | 65 | 66 | 70 | 61 | 62 | 65 | 62 | 63 | 61 |
| S50 | B50 | 66 | 65 | 74 | 64 | 60 | 61 | 62 | 58 | 64 |
| D | D | 63 | 62 | 62 | 62 | 61 | 64 | 63 | 62 | 64 |

TABLE 16
pH in muscle 3-4 days after bath treatment

| | | BASE min | | | | | | | | |
|---|---|---|---|---|---|---|---|---|---|---|
| | | 1 | 1 | 1 | 30 | 30 | 30 | 60 | 60 | 60 |
| | | ACID min | | | | | | | | |
| | | DIP | 2 | 10 | DIP | 2 | 10 | DIP | 2 | 10 |
| S12 | B12 | 6.3 | 6.2 | 6.1 | 6.5 | 6.4 | 6.3 | 6.4 | 6.5 | 6.3 |
| S12 | B25 | 6.3 | 6.3 | 6.2 | 6.7 | 6.7 | 6.4 | 6.7 | 6.7 | 6.4 |
| S12 | B50 | 6.3 | 6.5 | 6.3 | 7.1 | 7.0 | 6.9 | 7.3 | 7.3 | 7.3 |
| S25 | B12 | 6.2 | 6.1 | 6.0 | 6.4 | 6.2 | 6.1 | 6.5 | 6.4 | 6.1 |
| S25 | B25 | 6.2 | 6.1 | 5.9 | 6.6 | 6.4 | 6.3 | 6.8 | 6.8 | 6.5 |
| S25 | B50 | 6.4 | 6.3 | 6.0 | 7.2 | 7.5 | 6.7 | 7.6 | 7.5 | 6.9 |
| S50 | B12 | 6.1 | 5.9 | 5.5 | 6.8 | 6.0 | 5.8 | 6.4 | 6.2 | 5.9 |
| S50 | B25 | 6.0 | 5.9 | 5.6 | 6.6 | 6.3 | 6.1 | 6.5 | 6.5 | 6.0 |
| S50 | B50 | 6.2 | 6.1 | 5.5 | 6.3 | 6.9 | 6.7 | 7.4 | 7.9 | 6.7 |
| D | D | 6.3 | 6.2 | 6.2 | 6.3 | 6.3 | 6.1 | 6.3 | 6.4 | 6.2 |

TABLE 17
Dry matter in muscle after bath treatment

| | | BASE min | | | | | | | | |
|---|---|---|---|---|---|---|---|---|---|---|
| | | 1 | 1 | 1 | 30 | 30 | 30 | 60 | 60 | 60 |
| | | ACID min | | | | | | | | |
| | | DIP | 2 | 10 | DIP | 2 | 10 | DIP | 2 | 10 |
| S12 | B12 | 22.2 | 20.9 | 21.5 | 20.3 | 20.3 | 20.5 | 20.6 | 22.2 | 18.7 |
| S12 | B25 | 20.9 | 21.0 | 22.8 | 20.6 | 20.2 | 20.3 | 20.6 | 20.2 | 20.1 |
| S12 | B50 | 21.6 | 20.7 | 22.0 | 19.6 | 20.3 | 19.8 | 20.2 | 21.2 | 19.3 |
| S25 | B12 | 22.1 | 21.8 | 24.3 | 21.5 | 20.7 | 22.0 | 22.4 | 21.4 | 22.0 |
| S25 | B25 | 21.4 | 23.0 | 26.2 | 21.2 | 20.6 | 20.5 | 19.9 | 20.1 | 20.9 |
| S25 | B50 | 22.5 | 20.4 | 24.2 | 19.9 | 19.3 | 20.7 | 19.6 | 19.8 | 19.0 |
| S50 | B12 | 23.9 | 24.2 | 27.1 | 20.0 | 22.3 | 25.0 | 21.4 | 22.1 | 23.1 |
| S50 | B25 | 23.1 | 24.1 | 28.0 | 20.8 | 20.5 | 23.1 | 22.1 | 21.2 | 21.6 |
| S50 | B50 | 21.2 | 20.8 | 25.5 | 20.8 | 20.4 | 19.7 | 21.6 | 19.8 | 20.1 |
| D | D | 23.0 | 21.4 | 23.3 | 21.4 | 20.7 | 20.9 | 21.2 | 23.1 | 20.4 |

### REFERENCE LIST

Ang, J. F. & Haard, N. F. 1985. Chemical composition and post mortem changes in soft textured muscle from intensive feeding Atlantic cod (Gadus morhua, L), J Food Bioch. 9: 49-64
Landfald, B., Solberg, T & Christiansen, B. 1991. Farm-raised cod—a product with a difference. Norsk Fiskeoppdrett (Norwegian Fish Farming) 13: 26-27
Liakelv, M. 2003. Survey of quality properties in cod (Gadus morhua). Doctoral thesis for the Institute of Food Sciences and AKVAFORSK, NLH, page 68.
Losnegard, N., Langmyhr, E. & Madsen, D. 1986. Farmed cod, quality and use I: Chemical composition as a function of season. NFFR-no. V 709.001. Directorate of Fisheries, Bergen, page 17.
Love, R. M. 1979. The post mortem pH of cod and haddock muscle and its seasonal variations. J. Sci. Food Agric. 30: 433-438.
Love, R. M, Robertson, I., Smith, G. I. & Whittle, K. J. 1974. The texture of cod muscle. J. of Texture 5: 201-212.
Mçrkøre, T. 2002. Texture, fat content and production yield of salmonids (Doctor scientarum thesis). Department of Animal Science, Agricultural University of Animal Science, Ås, Norway.

Attachments

Attachment 1. Mixture ratio in grams of the various substances
used for mixing the pH-gradients in experiment 1.

| | pH 4 | pH 5 | pH 6 | pH 7 | pH 8 |
|---|---|---|---|---|---|
| Citric acid | 25.07 | 25.06 | 25.07 | 25.05 | 25.02 |
| (C₆H₈O₇), g | | | | | |
| Lye | 6.29 | 11.09 | 14.87 | 16.28 | 16.37 |
| (NaOH₃) g | | | | | |
| 2 l water | x | x | x | x | x |

Attachment 2. Randomising of pH-gradient-treated cod

| | piece | | | | |
|---|---|---|---|---|---|
| Fish | a | b | c | d | e |
| 1 | 4 | 5 | 6 | 7 | 8 |
| 2 | 8 | 4 | 5 | 6 | 7 |
| 3 | 7 | 8 | 4 | 5 | 6 |
| 4 | 6 | 7 | 8 | 4 | 5 |
| 5 | 5 | 6 | 7 | 8 | 4 |

Attachment 3. Average number for different measurement parameters in
experiment 1. Statistical differences between the various pH-gradient-
treatments are indicated by different letters.

| | pH before | | | | | |
|---|---|---|---|---|---|---|
| | treatment | | | | | |
| | 6.18 | | | | | |
| | pH 4 | pH 5 | pH 6 | pH 7 | pH 8 | p-value |
| pH after treatment | 6.19^{a} | 6.20^{a} | 6.28^{a} | 6.20^{a} | 6.23^{a} | 0.853 |
| Sensory evaluation | | | | | | |
| Firmness, points | 2.4^{a} | 2.3^{a} | 2.4^{a} | 2.4^{a} | 2.6^{a} | 0.0854 |
| Smell, points | 1.9^{a} | 1.7^{a} | 1.7^{a} | 2^{a} | 2^{a} | 0.7778 |
| Colour, points | 6.4^{a} | 6.5^{a} | 6.4^{a} | 6.1^{a} | 6.4^{a} | 0.9364 |
| Dry matter, % | 25.9^{a} | 24.6^{b} | 23.8^{c} | 23.7^{c} | 23.7^{c} | <0.0001 |
| Run-off, % | 8.3^{a} | 6.5^{ab} | 6.1^{b} | 6.6^{ab} | 5.5^{b} | 0.0326 |
| Instrumental lightness (image | | | | | | |
| analysis) | | | | | | |
| L*-value before treatment | 65.1^{a} | 65.1^{a} | 64.3^{ab} | 61.4^{b} | 64.4^{ab} | 0.234 |
| L*-value after treatment | 68.6^{a} | 67.5^{ab} | 66.5^{ab} | 63.9^{b} | 65.9^{ab} | 0.2014 |
| Instrumental firmness, force | | | | | | |
| measured in N with: | | | | | | |
| Fillet thickness in mm | 25.1^{a} | 25.8^{a} | 24.7^{a} | 24.7^{a} | 25.2^{a} | 0.9711 |
| 2 mm depression | 3.9^{a} | 3.5^{a} | 3.7^{a} | 3.7^{a} | 3.2^{a} | 0.5414 |
| 4 mm depression | 6.4^{a} | 5.7^{a} | 5.9^{a} | 6.6^{a} | 5.2^{a} | 0.5149 |
| 6 mm depression | 10.2^{a} | 8.6^{ab} | 8.7^{ab} | 8.0^{ab} | 7.2^{b} | 0.2724 |
| 8 mm depression | 33.1^{a} | 27.9^{b} | 22.5^{bc} | 23.7^{bc} | 22.2^{c} | 0.0004 |
| Rupture point | 13.3^{a} | 12.4^{ab} | 8.7^{b} | 9.16^{b} | 8.5^{b} | 0.0734 |

Attachment 4. Average number for different measurement parameters in
experiment 2 with different bath treatments on prerigor-filleted cod. Statistical
differences are indicated by different letters. Attachments 4 and 5 belong
together and are read together.

| | Prerigor Day 0 | | | Prerigor Day 6 | | |
|---|---|---|---|---|---|---|
| | Control | Soda | Citric acid | Control | Soda | Citric acid |
| On raw cod | | | | | | |
| pH after treatment | 6.29^{b} | 6.56^{a} | 5.99^{c} | 6.3^{ab} | 6.48^{a} | 6.13^{b} |
| Sensory evaluation | | | | | | |
| Firmness, points | 4.6^{a} | 5^{a} | 5^{a} | 4.5^{ab} | 4.2^{b} | 5^{a} |
| Smell, points | 1.6^{a} | 1.4^{a} | 0.2^{b} | 1.5^{ab} | 1.6^{a} | 1^{b} |
| Colour, points | 6^{b} | 6^{b} | 8^{a} | 6.3^{b} | 5.6^{c} | 8^{a} |
| Gaping, points | 0.4^{b} | 0^{b} | 4^{a} | 0.5^{b} | 1.2^{ab} | 2^{a} |
| Transverse gaping, points | 0^{a} | 0^{a} | 0.4^{a} | 0^{a} | 0^{a} | 0^{a} |
| Longitudinal gaping, | 0.4^{b} | 0^{c} | 2^{a} | 0.3^{b} | 1^{a} | 1^{a} |
| points | | | | | | |
| Water loss analyses | | | | | | |
| Dry matter, % | 22.4^{b} | 23.1^{b} | 26.1^{a} | 20.8^{ab} | 19.7^{b} | 21.3^{a} |
| Run-off, % | 7.7^{ab} | 6.0^{b} | 9.7^{a} | 6.8^{ab} | 5.0^{b} | 10.2^{a} |
| Centrifuging, % | 11.8^{a} | 8.8^{a} | 12.0^{a} | 11.4^{b} | 6.7^{c} | 18.3^{a} |
| Instrumental lightness | | | | | | |
| (image analysis) | | | | | | |
| L*-value back | 48.1^{b} | 45.6^{c} | 74.6^{a} | 47.5^{b} | 44.6^{c} | 76.4^{a} |
| L*-value neck | 48.6^{b} | 42.8^{c} | 73.1^{a} | 48.8^{b} | 46.1^{b} | 76.2^{a} |
| L*-value tail | 49.8^{b} | 45.4^{c} | 75.6^{a} | 51.0^{b} | 47.9^{c} | 76.3^{a} |
| L*-mean value | 48.9^{b} | 44.6^{c} | 74.4^{a} | 49.1^{b} | 46.2^{c} | 76.3^{a} |
| Instrumental firmness, | | | | | | |
| force measured in N | | | | | | |
| Back | | | | | | |
| Fillet thickness in mm | 19.0^{a} | 18.0^{a} | 17.9^{a} | 16.9^{a} | 16.6^{a} | 16.5^{a} |
| 2 mm depression | 2.4^{a} | 2.1^{a} | 2.0^{a} | 3.4^{a} | 3.3^{a} | 3.9^{a} |
| 4 mm depression | 5.2^{a} | 4.0^{a} | 4.1^{a} | 6.6^{a} | 6.6^{a} | 7.0^{a} |
| 6 mm depression | 7^{a} | 5.9^{a} | 5.5^{a} | 6.4^{a} | 6.2^{a} | 7.3^{a} |
| 8 mm depression | 15.5^{a} | 14.4^{a} | 16.1^{a} | 13.6^{a} | 15.0^{a} | 14.7^{a} |
| 14 mm depression | 14.0^{ab} | 11.5^{b} | 16.1^{a} | 14.8^{b} | 13.6^{b} | 17.8^{a} |
| Rupture | 7.9^{a} | 7.9^{a} | 6.9^{a} | 8.5^{a} | 7.0^{a} | 8.4^{a} |
| Tail | | | | | | |
| Fillet thickness in mm | 15.2^{a} | 14.8^{a} | 14.7^{a} | 14.2^{a} | 14.1^{a} | 14.0^{a} |
| 2 mm depression | 3.6^{a} | 3.2^{a} | 2.8^{a} | 3.4^{a} | 2.8^{a} | 2.9^{a} |
| 4 mm depression | 7.9^{a} | 7.5^{a} | 6.1^{a} | 7.2^{a} | 6.5^{a} | 6.7^{a} |
| 6 mm depression | 7.7^{a} | 7.8^{a} | 7.9^{a} | 8.2^{a} | 7.8^{a} | 8.9^{a} |
| 8 mm depression | 13.7^{a} | 13.2^{a} | 13.2^{a} | 12.8^{a} | 12.7^{a} | 12.6^{a} |
| 12 mm depression | 15.8^{a} | 13.8^{a} | 16.4^{a} | 16.1^{a} | 13.6^{a} | 19.4^{a} |
| Rupture | 9.1^{a} | 9.1^{a} | 8.1^{a} | 8.4^{a} | 8.2^{a} | 9.2^{a} |

Attachment 5. Average number for different measurement parameters in
experiment 2 with different bath treatments on postrigor-filleted cod. Statistical
differences are indicated by different letters. Attachments 4 and 5 belong
together and are read together.

| | Postrigor Day 6 | | | Postrigor Freeze | | |
|---|---|---|---|---|---|---|
| | Control | Soda | Citric acid | Control | Soda | Citric acid |
| On raw cod | | | | | | |
| pH after treatment | 6.32^{b} | 6.75^{a} | 5.81^{c} | 6.31^{b} | 6.67^{a} | 5.86^{c} |
| Sensory evaluation | | | | | | |
| Firmness, points | 3.4^{a} | 4^{a} | 3.6^{a} | 3^{a} | 3^{ef} | 2.9^{f} |
| Smell, points | 1.7^{a} | 1.4^{a} | 1.3^{a} | 1^{a} | 1.4^{a} | 1^{a} |
| Colour, points | 6.1^{b} | 5^{c} | 8^{a} | 6.1^{b} | 6^{b} | 8^{a} |
| Gaping, points | 2^{b} | 1.4^{c} | 3^{a} | 2.9^{a} | 2.9^{a} | 3.1^{a} |
| Transverse gaping, points | 0.6^{b} | 0.1^{b} | 1.4^{a} | 1^{a} | 1^{a} | 1.4^{a} |
| Longitudinal gaping, | 1^{ab} | 0.9^{c} | 1.3^{a} | 1^{a} | 1^{a} | 0.9^{a} |
| points | | | | | | |
| Water loss analyses | | | | | | |
| Dry matter, % | 19.7^{b} | 19.1^{b} | 25.1^{a} | 21.2^{b} | 19.5^{c} | 23.3^{a} |
| Run-off, % | 7.7^{b} | 5.9^{b} | 10.8^{a} | 19.4^{b} | 11.1^{c} | 22.8^{a} |
| Centrifuging, % | 10.7^{a} | 10.0^{a} | 12.3^{a} | 26.5^{a} | 21.3^{c} | 29.4^{a} |
| Instrumental lightness | | | | | | |
| (image analysis) | | | | | | |
| L*-value back | 54.2^{b} | 48.9^{c} | 78.6^{a} | 65.0^{b} | 60.8^{c} | 72.0^{a} |
| L*-value neck | 54.4^{b} | 49.1^{c} | 77.7^{a} | 62.4^{b} | 60.1^{b} | 71.5^{a} |
| L*-value tail | 54.6^{b} | 50.5^{c} | 80.2^{a} | 61.7^{b} | 59.5^{b} | 71.5^{a} |
| L*-mean value | 54.4^{b} | 49.5^{c} | 78.9^{a} | 63.0^{b} | 60.1^{b} | 71.7^{a} |
| Instrumental firmness, | | | | | | |
| force measured in N | | | | | | |
| Back | | | | | | |
| Fillet thickness in mm | 13.7^{a} | 13.1^{a} | 11.7^{a} | 15.6^{a} | 13.5^{a} | 14.8^{a} |
| 2 mm depression | 2.8^{a} | 3.0^{a} | 3.7^{a} | 1.5^{a} | 2.2^{a} | 1.6^{a} |
| 4 mm depression | 3.9^{b} | 4.9^{a} | 6.5^{a} | 3.1^{a} | 4.7^{a} | 3.4^{a} |
| 6 mm depression | 3.5^{b} | 5.6^{b} | 10.0^{a} | 5.6^{a} | 7.5^{a} | 6.2^{a} |
| 8 mm depression | 7.5^{a} | 12.0^{a} | 10.4^{a} | 22.0^{a} | 16.7^{b} | 22.0^{a} |
| 14 mm depression | 9.2^{b} | 11.2^{b} | 23.2^{a} | 22.0^{a} | 16.7^{b} | 22.0^{a} |
| Rupture | 4.6^{b} | 5.9^{ab} | 7.5^{a} | 9.6^{a} | 8.8^{a} | 8.0^{a} |
| Tail | | | | | | |
| Fillet thickness in mm | 12.4^{a} | 11.0^{a} | 11.0^{a} | 12.5^{b} | 12.6^{b} | 13.6^{a} |
| 2 mm depression | 3.2^{b} | 4.2^{a} | 3.7^{ab} | 2.0^{a} | 2.1^{a} | 1.9^{a} |
| 4 mm depression | 5.2^{b} | 6.5^{ab} | 6.8^{a} | 4.2^{a} | 4.2^{a} | 4.0^{a} |
| 6 mm depression | 5.6^{b} | 7.0^{b} | 9.3^{a} | 5.6^{a} | 6.1^{a} | 6.5^{a} |
| 8 mm depression | 11.3^{a} | 11.0^{a} | 10.0^{a} | 16.7^{a} | 14.5^{a} | 19.1^{a} |
| 12 mm depression | 11.5^{b} | 12.7^{b} | 18.5^{a} | 16.7^{a} | 14.5^{a} | 19.1^{a} |
| Rupture | 6.0^{b} | 6.8^{b} | 8.1^{aa} | 7.1^{a} | 6.3^{a} | 7.2^{a} |

Attachment 6. Average number and p-values for different measurement
parameters for prerigor- and postrigor-filleted cod in experiment 2.
Statistical differences are indicated by different letters.

| | Prerigor | Prerigor | Postrigor | Postrigor | |
|---|---|---|---|---|---|
| | Day 0 | Day 6 | Day 6 | Freeze | p-value |
| On raw cod | | | | | |
| pH after treatment | 6.28^{a} | 6.30^{a} | 6.29^{a} | 6.28^{a} | 0.997 |
| Sensory evaluation | | | | | |
| Firmness, points | 4.8^{a} | 4.6^{a} | 3.8^{b} | 2.9^{c} | <0.0001 |
| Smell, points | 1.1^{a} | 1.4^{a} | 1.2^{a} | 1.1^{a} | 0.124 |
| Colour, points | 6.7^{a} | 6.6^{a} | 6.4^{a} | 6.7^{a} | 0.772 |
| Gaping, points | 1.5^{bc} | 0.0^{c} | 0.7^{a} | 1.1^{a} | 0.0004 |
| Transverse gaping, points | 0.1^{c} | 0.0^{c} | 0.7^{b} | 1.1^{a} | <0.0001 |
| Longitudinal gaping, | 0.8^{a} | 0.8^{a} | 1.1^{a} | 1.0^{a} | 0.401 |
| points | | | | | |
| Water loss analyses | | | | | |
| Dry matter, % | 23.9^{a} | 20.6^{b} | 21.3^{b} | 21.3^{b} | 0.0010 |
| Run-off, % | 7.8^{b} | 7.3^{b} | 8.1^{b} | 17.8^{a} | <0.0001 |
| Centrifuging, % | 10.9^{b} | 12.1^{b} | 11.0^{b} | 25.7^{a} | <0.0001 |
| Instrumental lightness | | | | | |
| (image analysis) | | | | | |
| L*-value back | 58.1^{b} | 56.8^{b} | 60.6^{ab} | 65.9^{a} | 0.072 |
| L*-value neck | 54.9^{b} | 57.6^{ab} | 60.4^{ab} | 64.7^{a} | 0.099 |
| L*-value tail | 56.9^{b} | 59.0^{a} | 61.8^{a} | 64.2^{a} | 0.301 |
| L*-mean value | 56.0^{b} | 57.8^{ab} | 60.9^{ab} | 64.9^{a} | 0.133 |
| Instrumental firmness, | | | | | |
| force measured in N | | | | | |
| Back | | | | | |
| Fillet thickness in mm | 18.3^{a} | 16.7^{b} | 12.8^{d} | 14.6^{c} | <0.0001 |
| 2 mm depression | 2.2^{b} | 3.6^{a} | 3.2^{a} | 1.8^{b} | <0.0001 |
| 4 mm depression | 4.4^{bc} | 6.8^{a} | 5.1^{b} | 3.7^{c} | 0.0001 |
| 6 mm depression | 6.1^{a} | 6.7^{a} | 6.4^{a} | 6.5^{a} | 0.967 |
| 8 mm depression | 15.3^{b} | 14.5^{b} | 10.0^{c} | 20.2^{a} | <0.0001 |
| 14 mm depression | 13.8^{b} | 15.5^{b} | 14.5^{b} | 20.2^{a} | 0.0012 |
| Rupture | 7.6^{a} | 7.9^{a} | 6.0^{b} | 8.8^{a} | 0.0007 |
| Tail | | | | | |
| Fillet thickness in mm | 14.9^{a} | 14.1^{a} | 11.5^{c} | 12.9^{b} | <0.0001 |
| 2 mm depression | 3.^{2ab} | 3.0^{b} | 3.7^{a} | 2.0^{c} | <0.0001 |
| 4 mm depression | 7.2^{a} | 6.8^{ab} | 6.2^{b} | 4.1^{c} | <0.0001 |
| 6 mm depression | 7.8^{ab} | 8.3^{a} | 7.3^{b} | 6.0^{c} | 0.0034 |
| 8 mm depression | 13.4^{b} | 12.7^{ab} | 10.7^{c} | 16.8^{a} | <0.0001 |
| 12 mm depression | 15.3^{ab} | 16.4^{ab} | 14.2^{b} | 16.8^{a} | 0.2040 |
| Rupture | 8.8^{a} | 8.6^{a} | 7.0^{b} | 6.8^{b} | <0.0001 |

Attachment 7. Average number and p-values (for prerigor-filleted and
postrigor-filleted cod) for measurement parameters in experiment 3, with
different bath treatments and at two different filleting times. Statistical
differences between treatments within the filleting time (prerigor and postrigor)
are indicated by different letters.

| | Prerigor- | | | Postrigor- | | | |
|---|---|---|---|---|---|---|---|
| | filleted | | | filleted | | | |
| On cooked cod | Control | Soda | Citric acid | Control | Soda | Citric acid | P-value |
| Firmness, points | 3.8^{a} | 3.5^{a} | 3.9^{a} | 3.6^{a} | 3.3^{a} | 3.5^{a} | 0.28 |
| Dryness, points | 2.8^{b} | 3.6^{a} | 2.5^{b} | 3.1^{ab} | 3.7^{a} | 2.4^{b} | 0.83 |
| Smell, points | 2.8^{b} | 3.1^{ab} | 2.6^{b} | 3.1^{ab} | 3.4^{a} | 3.2^{ab} | 0.02 |
| Tastiness, points | 3.3^{ab} | 3.6^{a} | 2^{c} | 3.8^{a} | 3.7^{a} | 2.8^{b} | 0.12 |
| Lightness, points | 3.4^{ab} | 3.5^{ab} | 4^{ab} | 3.8^{ab} | 3.3^{b} | 4.5^{a} | 0.03 |
| L*-value before | 62.9^{c} | 60.5^{d} | 66.7^{b} | 63.7^{c} | 62.7^{c} | 69.1^{a} | 0.03 |
| cooking | | | | | | | |
| L*-value after | 71.9^{cd} | 64.9^{e} | 73.2^{bc} | 73.7^{b} | 71.1^{d} | 76.1^{a} | <0.001 |
| cooking | | | | | | | |

Attachment 8. Average values and p-values for different parameters for
different filleting times in experiment 3. Statistical differences are
indicated by different letters.

| | Prerigor-filleted | Postrigor-filleted | p-value |
|---|---|---|---|
| On raw fillet | | | |
| pH before treatment | 6.34^{a} | 6.28^{b} | 0.0418 |
| Firmness, points | 3.7^{a} | 2.6^{b} | <0.0001 |
| Smell, points | 1^{a} | 1^{a} | — |
| Lightness, points | 5.1^{b} | 6.5^{a} | <0.0001 |
| Gaping, points | 2.7^{a} | 2.6^{a} | 0.5681 |
| Solid material, % | 19.7^{a} | 19.9^{a} | 0.6126 |
| Run-off, % | 12.9^{a} | 11.8^{a} | 0.1445 |
| Sensory evaluation, | | | |
| cooked fillet | | | |
| Firmness, points | 3.9^{a} | 3.5^{a} | 0.2834 |
| Dryness, points | 3.0^{a} | 3.1^{a} | 0.8263 |
| Smell, points | 2.8^{b} | 3.2^{a} | 0.0182 |
| Tastiness, points | 3.0^{a} | 3.4^{a} | 0.1175 |
| Lightness, points | 3.3^{b} | 3.9^{a} | 0.0256 |
| L*-value before cooking | 63.4^{b} | 65.1^{a} | 0.0295 |
| L*-value after cooking | 70.3^{b} | 73.5^{a} | 0.0001 |

1. A method for treating skinless fish flesh, comprising exposing skinless fish flesh to a basic solution followed by exposing the flesh to an acidic solution whereby the relative exposure times are sufficient to cause the internal parts of the flesh t attain higher pH values than the surface parts.

2. (canceled)

3. (canceled)

4. A method according to claim 1, wherein the pH in the basic and the acidic solution is 8-9 and 1.5-3 respectively.

5. A method according to claim 4, wherein the exposure is conducted by the fish flesh being lowered into basic and acidic baths, sprayed with basic and acidic solutions, or injected with basic and acidic solutions, or a combination of these methods of exposure.

6. A method according to claim 5, wherein the exposure is conducted by the fish flesh being lowered into a baths consisting of basic and acidic solutions.

7. A method according to claim 1, wherein the base and the acid comprise compounds that are approved for use in foodstuffs.

8. A method according to claim 1, wherein the base is NaHCO₃ (E 500) and the acid is C₆H₈O₇ (E 330).

9. A method according to claim 1, wherein the fish flesh is selected from whole and cut fillets without skin, slices of fish flesh or minced fish flesh.

10. A method according to claim 8, wherein the exposure times for the fish flesh to basic and acidic solution respectively are selected with regard to its size, with the result that the exposure times increase with the volume.

11. A method according to claim 10, wherein the residence time in basic solution is 1 minute to 3 days and nights, and the residence time in acidic solution is at least 2 seconds (dipping) to 10 minutes,

12. A method according to claim 11, wherein the exposure time in basic solution is selected from 1 min to 60 min and the exposure time in acidic solution is selected from 2 sec (dipping) to 10 min for a piece of fish flesh measuring approximately 3 cm×3 cm×2 cm.

13. A method according to claim 11, wherein the residence time in basic solution is at least 12 hours.

14. A method according to claim 1, wherein the flesh is cod (Gadus morhua).

15. A method according to claim 14, wherein the cod is farmed cod.

16. A method according to claim 1, wherein the treatment is automated.

17. Fish flesh, wherein the pH value in the surface parts of the fish flesh is lower than the pH value in the internal parts of the flesh.

18. Fish flesh according to claim 17, wherein it is treated by the method according to either of claims 1 or 4-16.

19. (canceled)

20. A plant for treating fish flesh comprising devices for exposing the fish flesh to basic and acidic solutions respectively, packing devices, in addition to transport devices for transporting the flesh to the various treatment devices.
